(19) United States
(12) Patent Application Publication
(10) Pub. No.: US 2026/0300283 A1
(43) Pub. Date: Oct. 1, 2026

(54) DATA AUGMENTATION PIPELINE FOR MULTI-TURN TEXT-TO-SQL

(71) Applicant: Oracle International Corporation, Redwood Shores, CA (US)

(72) Inventors: Bhagya Gayathri Hettige, Melbourne (AU); Qianyu Feng, Sydney (AU); Varsha Kuppur Rajendra, Bellevue, WA (US); Mohammad Najafi, Melbourne (AU); Dalu Guo, Sydney (AU); Duy Vu, Melbourne (AU); Yakupitiyage Don Thanuja Samodhye Dharmasiri, Melbourne (AU)

(73) Assignee: Oracle International Corporation, Redwood Shores, CA (US)

(21) Appl. No.: 19/576,611

(22) Filed: Mar. 24, 2026

Related U.S. Application Data
(60) Provisional application No. 63/777,324, filed on Mar. 25, 2025.

(51) Int. Cl. G06F 16/2452; G06F 16/21; G06N 20/00

(52) U.S. Cl. CPC G06F 16/24522; G06F 16/217; G06N 20/00

(57) ABSTRACT

Techniques are provided for generating context-aware, multi-turn natural language to SQL training data for database query models. The method involves accessing reference data that includes natural language utterances and corresponding queries in a programming query language. An AI model may generate a set of follow-up natural language utterances based on contextual information related to an initial utterance, and may rewrite these utterances to produce self-contained, multi-turn queries. An AI model can retrieve examples from the reference data that are semantically similar to the multi-turn utterances, serving as in-context examples. An AI model may then generate candidate queries based on the rewritten utterances and the retrieved examples. A dual stage validation process can be executed to evaluate the candidate queries, generating performance reports indicating which queries pass validation. Multi-turn training data comprising the validated utterances and their corresponding queries may then be generated for use in training database query models.

### CROSS REFERENCE TO RELATED APPLICATIONS

The present application claims the benefit of U.S. Provisional Application No. 63/777,324 filed on Mar. 25, 2025, the entire disclosure of which is hereby incorporated herein by reference in its entirety for all purposes.

### FIELD

The present disclosure relates generally to machine learning techniques for natural language processing, and more particularly, to systems and methods for generating context-aware, multi-turn natural language to SQL training data for database query models.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents techniques for the implementation and improvement of text-to-query language technologies, including SQL, ensuring that the benefits of these advancements can be realized across various domains.

### BRIEF SUMMARY

Machine learning techniques are disclosed herein (e.g., a computer implemented method, a system, non-transitory computer-readable medium storing code or instructions executable by one or more processors) for generating context-aware, multi-turn natural language to SQL training data for database query models. To achieve this, a multi-turn NL2SQL data generation pipeline is described that generates high-quality, contextually relevant natural language and corresponding SQL data for databases, with a focus on multi-turn conversational interactions. The approach enables a large language model to simulate realistic sequences of user queries and follow-up questions, where each turn in the conversation may depend on previous questions, prior execution results, or user feedback. The system operates using a database schema and an initial user query, then generates follow-up queries of various dependency types such as referential, filtering, and modifying, each annotated to reflect its contextual relationships. These context-dependent queries are automatically rewritten into self-contained forms to facilitate accurate SQL generation. The pipeline integrates automated SQL ground truth creation aligned with the database schema, validates the generated SQL through execution on the database, and applies a checklist-based evaluation to ensure correctness. If errors are detected, the process iteratively refines the queries using feedback from both execution outcomes and evaluation criteria, simulating a user correction process. The system further augments its data by incorporating user feedback and execution-driven error scenarios, enabling the language model to learn from both its mistakes and corrective interactions. This framework aims to model real-world user interactions with databases, enhancing the accuracy, reliability, and robustness of text-to-SQL systems for practical, context-sensitive applications.

In various embodiments, a computer implemented method comprises: accessing reference data comprising natural language utterances and corresponding queries in a programming query language; executing, by one or more generative models, a natural language utterance generation process to generate multi-turn natural language utterances, wherein executing comprises: generating, by one of the one or more generative models, a set of follow-up natural language utterances based on contextual information relating to a natural language utterance in the reference data, and rewriting, by one of the one or more generative models, the set of follow-up natural language utterances to generate self-contained multi-turn natural language utterances; executing, by one or more artificial intelligence (AI) models, a query generation process to generate candidate queries corresponding to the multi-turn natural language utterances, wherein executing comprises: retrieving, by one of the one or more AI models, one or more examples from the reference data having a natural language utterance that is semantically similar to the multi-turn natural language utterances, wherein the retrieved one or more examples are in-context examples, generating, by one of the one or more AI models, candidate queries based on the multi-turn natural language utterances and the in-context examples, and executing, using one of the one or more AI models, a dual stage validation process on the candidate queries, wherein the dual stage validation process generates performance reports indicating whether a candidate query passes the dual stage validation process; and generating multi-turn natural language to query training data comprising the multi-turn natural language utterances and corresponding candidate queries that pass the dual stage validation process.

In various embodiments, generating the set of follow-up natural language utterances comprises providing, as part of a prompt to one of the one or more generative models, a follow-up trajectory that specifies logical dependency types for the follow-up natural language utterances and a target database schema.

In various embodiments, the follow-up natural language utterances comprise referential-based utterances, referential-result based utterances, filtering utterances, modifying utterances, utterances simulating database execution errors, utterances simulating user feedback, or any combination thereof.

In various embodiments, the rewriting comprises integrating contextual elements from the natural language utterance in the reference data, previous follow-up utterances in the set of follow-up natural language utterances, or both.

In various embodiments, the dual stage validation process comprises: executing the candidate queries against a database schema; receiving execution reports indicating whether each candidate query executed correctly; evaluating, by one of the one or more AI models, the candidate queries according to evaluation criteria; receiving evaluation reports indicating whether each candidate query passed the evaluation criteria; and aggregating the results in the execution reports and the evaluation reports to determine whether a candidate query passes the dual validation, wherein the performance reports comprise the execution reports and the evaluation reports.

In various embodiments, the dual stage validation process further comprises: when candidate queries fail a first stage of the dual stage validation process, a second stage of the dual stage validation process, or both: executing, by one of the one or more AI models, an iterative refinement loop, wherein the performance reports for the failed candidate queries and simulated user feedback utterances are incorporated into a prompt of the AI model and the iterative refinement loop repeats the dual stage validation process for one or a predetermined number of iterations, or until a candidate query passes the first stage and the second stage of the dual stage validation process.

In various embodiments, the method further comprising training a generative model using the multi-turn natural language to query training data.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL model, according to various embodiments.

FIG. 5 is a block diagram illustrating a multi-turn NL2SQL data augmentation pipeline, according to various embodiments.

FIG. 6 is a flowchart illustrating a process for generating context-aware, multi-turn natural language to SQL training data for database query models, according to various embodiments.

FIG. 7 is a block diagram illustrating one pattern for implementing a cloud infrastructure as a service system, according to various embodiments.

FIG. 8 is a block diagram illustrating another pattern for implementing a cloud infrastructure as a service system, according to various embodiments.

FIG. 9 is a block diagram illustrating another pattern for implementing a cloud infrastructure as a service system, according to various embodiments.

FIG. 10 is a block diagram illustrating another pattern for implementing a cloud infrastructure as a service system, according to various embodiments.

FIG. 11 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering different industries and their systems have been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of their business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with databases via natural language (NL) queries, thereby abstracting away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, such as SQL, PQL, GraphQL, and SPARQL among others. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL can also enable digital assistants, such as chatbots and others, to provide improved responses when answers can be found across different databases or tables with varying schemas.

In some instances, NL2SQL transforms natural language into SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token from the fixed vocabulary should appear next in the output sequence.

SQL is a standard database management language for interacting with relational databases. SQL can be used for storing, manipulating, retrieving, and/or otherwise managing data held in a relational database management system (RDBMS) and/or for stream processing in a relational data stream management system (RDSMS). The main goal of the Text-to-SQL model is to allow end users interact with their SQL databases through natural languages (NL) rather than SQL queries. Using a Text-to-SQL service, business analysts can extract information from their databases without thorough knowledge of SQL and the database schemas. In addition to the database schema, the main input to the Text-to-SQL model is a natural language question. For example: “tell me invoices starting with IBY7”. The main output from the Text-to-SQL model is an SQL query. For example: “SELECT*FROM accounts_payable_invoices WHERE LOWER(INVOICE_NUMBER) LIKE LOWER(‘iby7%’)”.

While recent advances in large language models (LLMs) and prompt-driven NL2SQL techniques have significantly improved the translation of natural language questions into SQL queries, these approaches are predominantly tailored to isolated, single-turn interactions. As a result, existing systems often fail to capture the complexity and contextual dependencies inherent in real-world database querying, especially when users engage in multi-turn conversational exchanges that require the system to track, reference, and adapt to previous questions, results, and corrections. There remains a critical need for frameworks that not only understand schema and business logic, but also model the dynamic, context-aware nature of human-database interaction in practical applications.

The effectiveness of NL2SQL models in real-world applications is fundamentally limited by the absence of multi-turn training data that captures the complexity, contextual dependencies, and iterative corrections inherent in conversational database querying. Existing datasets and pipelines focus almost exclusively on single-turn queries, leaving models ill-equipped to interpret and resolve the nuanced references, follow-ups, and user-driven corrections that characterize multi-turn database engagements. Without comprehensive data reflecting these dialog patterns (e.g., schema navigation, error handling, and feedback-driven refinement), NL2SQL systems struggle with conversational coherence, accurate query generation, and practical usability in enterprise and specialized domains.

To overcome these challenges and others, the present disclosure introduces an end-to-end data augmentation pipeline for generating context-aware, multi-turn sequences of natural language queries by leveraging seed data, schema context, and proposed conversational trajectories to produce diverse follow-up questions and their dependencies. Each natural language query is contextually rewritten to be self-contained, enabling compatibility with single-turn NL2SQL models. The pipeline further integrates automated SQL query generation, execution-guided validation, and checklist-based evaluation, supporting iterative refinement of candidate SQL queries. The pipeline augments the multi-turn training data by incorporating execution-based error scenarios and simulating user-driven corrections, so that NL2SQL models are exposed to and can learn from both failure modes and successful query reformulations. Through this process, the disclosed approach produces high-quality, executable, and contextually grounded multi-turn training sets, comprised of paired natural language queries and corresponding SQL queries, that can substantially improve the robustness, reliability, and accuracy of NL2SQL systems in conversational environments.

In various embodiments, a computer implemented method is provided comprising: accessing reference data comprising natural language utterances and corresponding queries in a programming query language; executing, by one or more generative models, a natural language utterance generation process to generate multi-turn natural language utterances, wherein executing comprises: generating, by one of the one or more generative models, a set of follow-up natural language utterances based on contextual information relating to a natural language utterance in the reference data, and rewriting, by one of the one or more generative models, the set of follow-up natural language utterances to generate self-contained multi-turn natural language utterances; executing, by one or more artificial intelligence (AI) models, a query generation process to generate candidate queries corresponding to the multi-turn natural language utterances, wherein executing comprises: retrieving, by one of the one or more AI models, one or more examples from the reference data having a natural language utterance that is semantically similar to the multi-turn natural language utterances, wherein the retrieved one or more examples are in-context examples, generating, by one of the one or more AI models, candidate queries based on the multi-turn natural language utterances and the in-context examples, and executing, using one of the one or more AI models, a dual stage validation process on the candidate queries, wherein the dual stage validation process generates performance reports indicating whether a candidate query passes the dual stage validation process; and generating multi-turn natural language to query training data comprising the multi-turn natural language utterances and corresponding candidate queries that pass the dual stage validation process.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action is based at least in part on at least a part of the something.

### Overview of Agents and NL2SQL Framework

An agent (also referred to as a skill, chatbot, chatterbot, talkbot, digital assistant, or the like) is a computer program that can engage in conversations with end users. The agent can generally respond to natural language messages (e.g., questions or comments) through a messaging application that uses natural language messages. Enterprises may use one or more agent systems to communicate with end users through a messaging application. The messaging application, which may also be referred to as a channel, may be an end user's preferred messaging application that they have already installed and are familiar with. Thus, the end user does not need to download or install new applications in order to chat with the agent system. The messaging application may interface with, for example, over-the-top (OTT) messaging channels (such as Facebook Messenger, WhatsApp, WeChat, Line, Kik, Telegram, Talk, Skype, Slack, or SMS); virtual private assistants (such as Amazon Alexa, Google Assistant, Apple Siri, or Microsoft Cortana, accessible through devices like Amazon Echo, Google Home, Apple HomePod, or compatible mobile devices); mobile and web app extensions that add chat capabilities to native or hybrid/responsive apps or web applications; or voice-based input (such as devices or apps that utilize Siri, Google Assistant, Alexa, Cortana, or other speech-based interfaces).

End user may interact with the agent system through a conversational interaction (sometimes referred to as a conversational user interface (UI)), similar to interactions between people. In some cases, the interaction may include the end user providing an utterance such as the query: “Please retrieve all invoices greater than ten thousand dollars for the last four years for Customer Y”, to the agent, and the agent responding with a natural language response based on translation of the user's natural language query to an SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or another method of conveying a message. In some embodiments, the agent system may convert the content into a standardized logical form (e.g., an SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

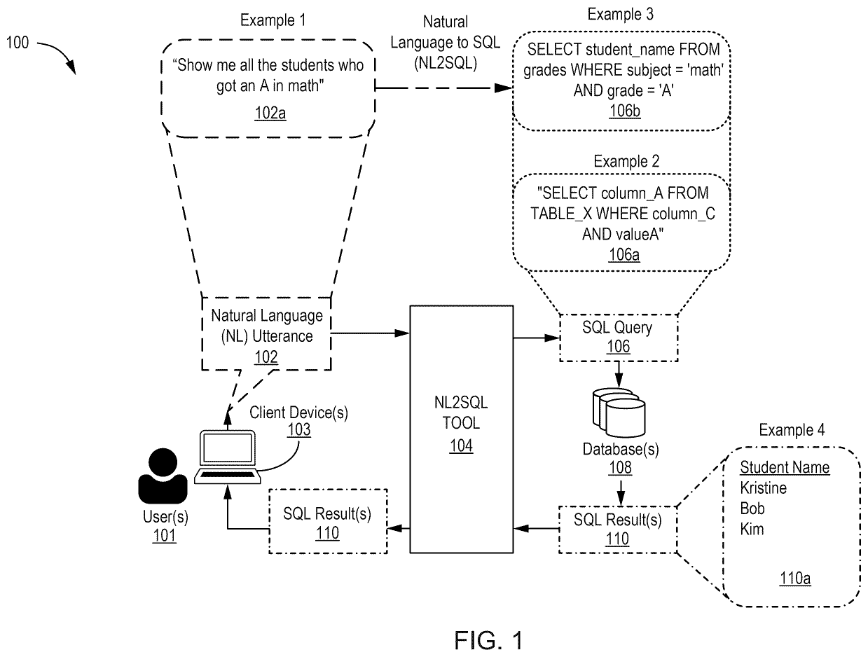

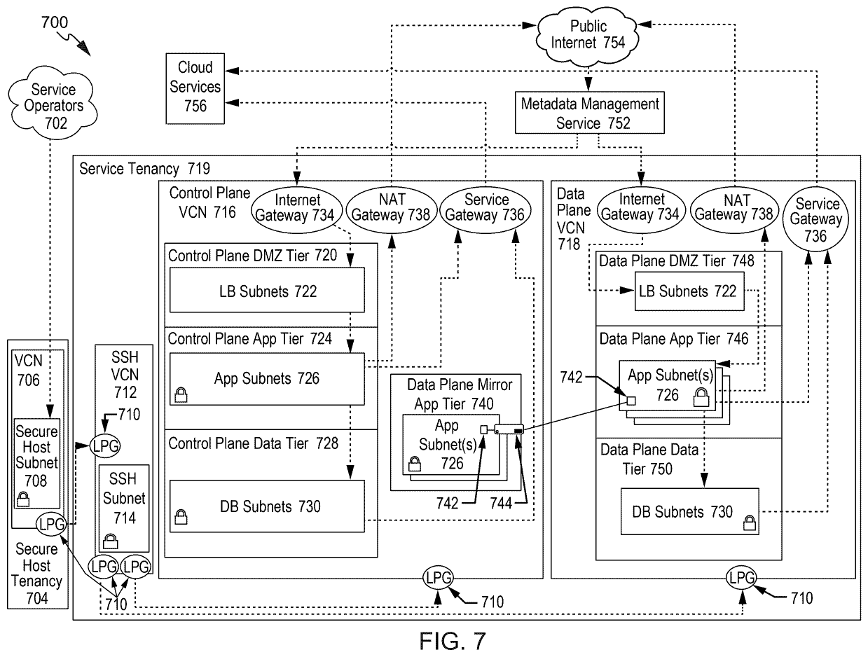

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for the query). As shown in FIG. 1, the NL2SQL tool 104 is configured to generate an SQL query 106 and one or more SQL query result(s) 110 based on the provided natural language utterance 102; however, other examples may implement tasks in addition to or in alternative to SQL query generation (e.g., schema checking, schema linking, sentence completion, extraction of key information, debugging, and other SQL-related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 7-11) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensuring high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be, or include a natural language utterance 102. The natural language utterance can be in text form, such as when the user types a sentence, a question, a text fragment, or phrase and provides it as input to the NL2SQL tool 104 via client device(s) 103. The client device(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone tool, as a plug-in, or make use of another audio-to-text translator, configured to translate the audio into text for further processing.

The NL2SQL tool 104 may be, or may make use of, one or more generative artificial intelligence models such as LLMs configured to generate an SQL query 106 (e.g., 106a or 106b) based on the natural language utterance 102. The NL2SQL tool 104 may receive a prompt including the natural language utterance 102 to generate an SQL query 106 that is relevant to the preferences of user 101. In some implementations, the user 101 and/or client device 103 generate a prompt including the natural language utterance 102 before providing the prompt to the NL2SQLtool 104. In other implementations, the NL2SQL tool 104 receives the natural language utterance 102 and generates the prompt itself, e.g., by populating slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain an SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via other means such as an email communication, SMS message, or other types of notification receivable on one or more other computing devices. In some implementations, the SQL query 106 is provided to the user(s) in addition to or instead of running the SQL query 106 on the database(s) 108 to obtain SQL result(s) 110 (e.g., as part of a feedback request to validate the SQL query 106).

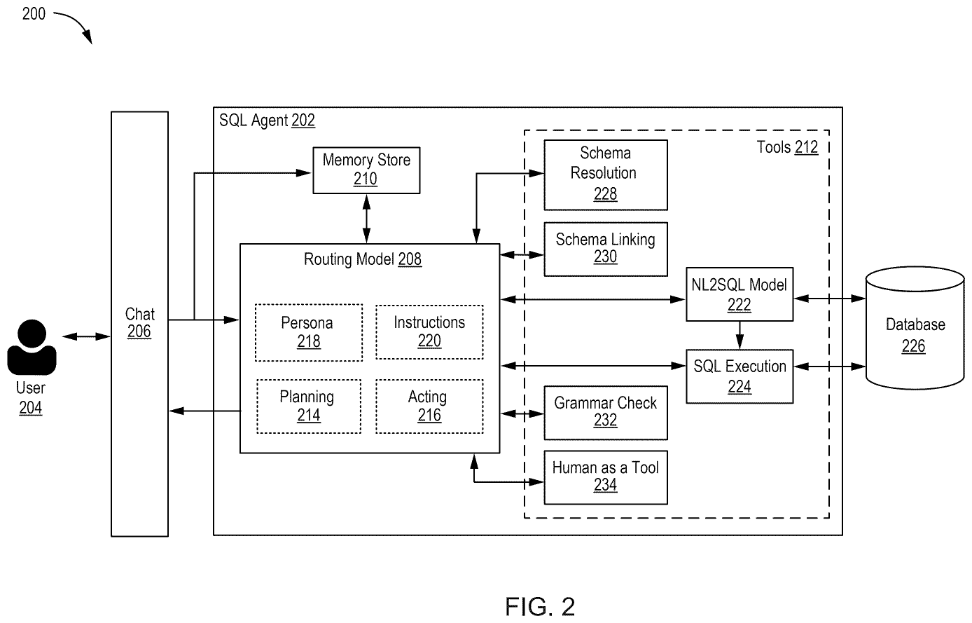

FIG. 2 is a simplified block diagram of an SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence models can generate SQL statements. The purpose of the SQL agent system 200 is to enable users to interact with their databases with the least amount of effort. This may include the SQL agent system 200 interpreting user requests in natural language, reviewing database schema, implementing schema linking (i.e. identifying names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include an SQL agent 202 capable of converting a natural language question into an SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that comprises a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates an SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve the accuracy of generated responses and customize responses generated by an LLM to the needs of the user 204. In some examples, planning 214 may select a tool from the tools 212 based on the persona 218.

TABLE 1

| Example | |
|---|---|
| Persona | Example Description |
| Junior | A user having limited to no experience in writing SQL queries |
| Developer | who requires assistance in writing and optimizing SQL |
| | queries. |
| Expert | A user with several years of experience writing SQL queries. |
| Developer | |
| Business | A user with strong context about the needs of a company |
| Analyst | and who wants quick data insights without deep SQL |
| | knowledge. |
| Data | A user focused on extracting and analyzing data efficiently. |
| Scientist | |

Instructions 220 describe the knowledge bases and tools available to the SQL agent 202. Instructions 220 can be included in a prompt for LLM-based tools and may guide a tool to generate a response relevant to the preferences of the user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates an SQL query based on the prompt. The NL2SQL model 222 can be trained to convert a natural language question into an SQL query to help the user 204 complete data related tasks. In some examples, the SQL query generated by the NL2SQL model 222 is returned to the user 204 via the chat 206. Additionally, or alternatively, the generated SQL query is provided to an SQL execution 224 tool that is configured to execute SQL queries on the database 226. SQL execution 224 may receive an SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate a new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within an SQL statement. The SQL agent 202 may use schema resolution 228 after an SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user, such as a developer, for information to correct previous generations.

The SQL agent 202 may use a single tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 204 via the chat 206 as received by the routing model 208 (i.e., without additional modifications to the output).

In some implementations, the routing model 208 responds to the user 204 who provided the original query as part of a two-way conversation (e.g., via chat 206). The natural language response may include a natural language component (e.g., answers to questions, information, etc.) and/or a logical form component (e.g., an SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 204 via the chat 206. In some implementations, the SQL agent 202 may provide a visualization of the generated output through a plot, table, graph, and the like, via the chat 206. As a particular example, the SQL agent 202 can use the schema linking 230 tool to identify names of tables and columns in a natural language utterance (which is an example of NL utterance 102 with respect to FIG. 1) provided by the user 204 and then generate an SQL query using the NL2SQL model 222 based on the identified table and column names. The SQL query may be provided to the user 204 via the chat 206 as generated by the NL2SQL model 222. In some implementations, the routing model 208 may generate a natural language response containing the SQL query and provide the natural language response to the user 204 via the chat 206.

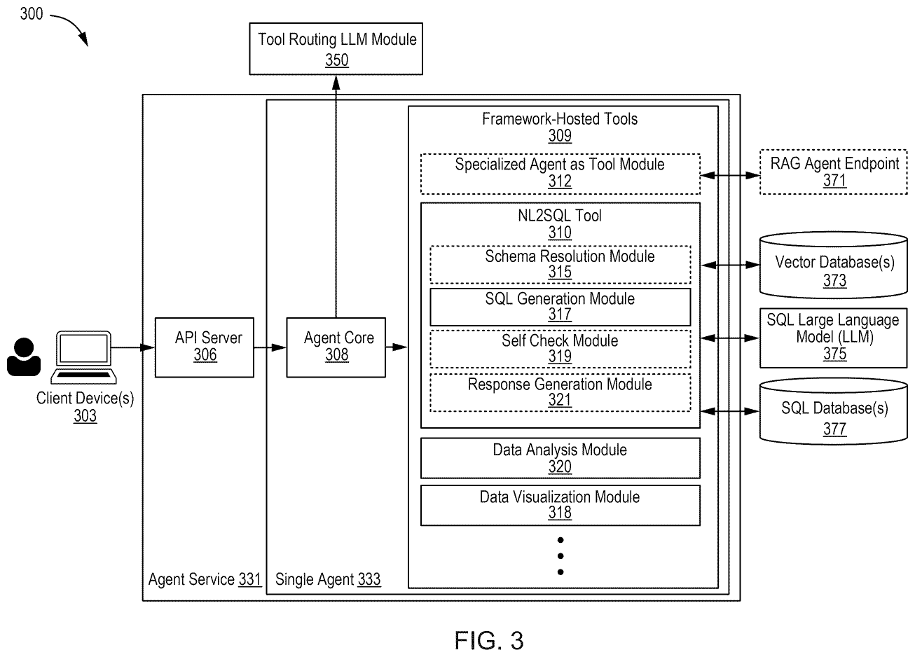

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to communicate as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval-augmented generation (RAG) endpoint 371. The RAG endpoint 371 may improve the efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework-hosted tools 309 is an NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schemas for any errors (e.g., syntax errors, semantic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is an SQL generation module 317. The SQL generation module 317 may take the utterance received from the client device(s) 303 and construct an SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with anyone or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 include data analysis module 320 and a data visualization module 318. Each of 320 and 318 may function with any of the modules of the framework-hosted tools 309 in order to analyze and display the various analytics. The analytics may include analysis of schema, SQL queries, LLM accuracy, recommendations, or suitable equivalents.

### Training, Testing, and Deployment of a NL2SQL Model

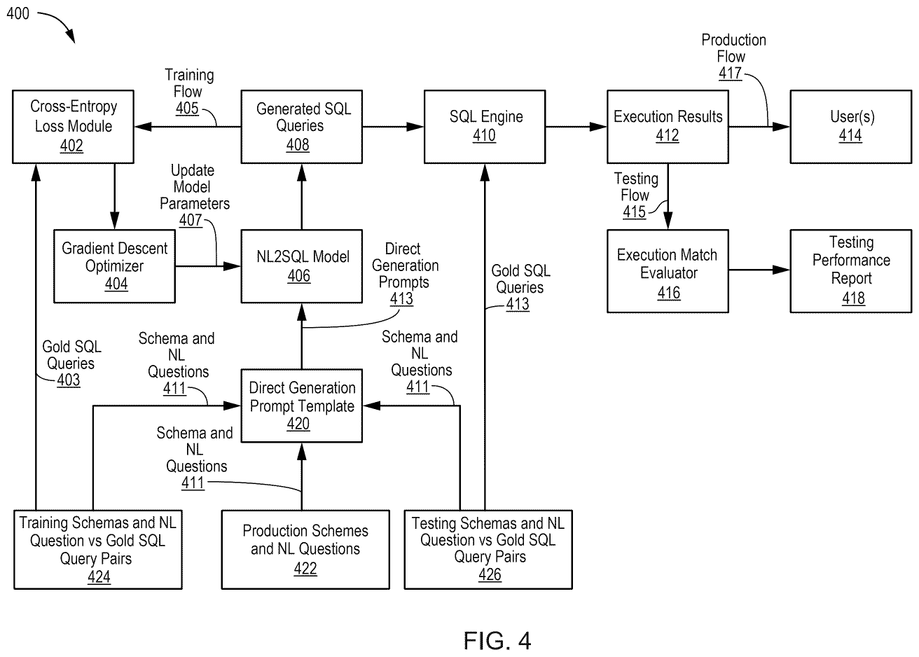

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the description below, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.
For example:
“Get me the list of employees from Australia.”
The main output from the NL2SQL model is an SQL query.
For example:
SELECT employee_id, employee_name FROM Employee WHERE country=“Australia”.
Another important input to the NL2SQL model 406 is the database schema that helps the model to identify relevant tables and columns in the SQL output construction.
For example:

```
CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
  ...
)
CREATE TABLE JobTitle (
  ...
)
...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATETABLE statements:
Table names
Column names and types
Primary and foreign keys
Other constraints

### One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0), origin TEXT(20), destination TEXT(20), distance NUMERIC(6,
0), departure_date DATE, arrival_date DATE, price NUMERIC(7, 2), aid NUMERIC(9,
0), PRIMARY KEY (flno), FOREIGN KEY(aid) REFERENCES aircraft (aid))
```

Each database schema can be associated with multiple pairs of natural language questions and corresponding SQL queries.

### Example of NL Question and Corresponding SQL Query:

NL Question: “What is the name of the employee with salary greater than 100000 and with the most certificates to fly planes more than 5000?”
SQL Query: “SELECTT1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BYT1.eid ORDER BY count(*) DESC LIMIT 1”

Each question-query pair and its corresponding database schema are populated following a NL2SQL direct generation prompt template to create one direct generation prompt example:
Direction NL2SQL Generation Prompt Example:
   Given an input Question, create a syntactically correct Oracle SQL query to run.
   Pay attention to using only the column names that you can see in the schema description.
   Be careful to not query for columns that do not exist. Also, pay attention to which column is in which table.
   Please double check the SQL query you generate.
   DO NOT use alias in the SELECT clauses.
   Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECTT1.name FROM employee AS T1 JOIN certificate AS T2 ON T1.eid=T2.eid
JOIN aircraft AS T3 ON T2.aid=T3.aid WHERE T3.distance>5000 AND T1.salary>100000 GROUP BY T1.eid ORDER BY count(*) DESC LIMIT 1”

The prompt example can then be sent to the LLM model to generate the SQL query during training and testing phases. The gold (ground truth) SQL Query: “SELECTT1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BYT1.eid ORDER BY count(*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs.) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing.

The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine teaming models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using an SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model—its ability to perform well across different data samples and environments—highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 7-11).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into an SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:
“sql
SELECT*FROM customers WHERE signup_date>=DATE_SUB(CURDATE( ), INTERVAL 1 MONTH);
”

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using an SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected overtime. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original data set. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. For example, Large Vision Language Models (VLMs) are advanced AI systems that integrate computer vision and natural language processing (NLP) to process and generate text based on visual inputs like images or videos. These models are multimodal, meaning they can handle both text and visual data simultaneously, enabling tasks such as image captioning, visual question answering (VQA), image generation, and object detection. These models integrate diverse data sets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse data sets that include paired data from different modalities. This computationally intensive process often requires specialized hardware like GPUs orTPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Data Augmentation Pipeline for Multi-Turn Text-to-SQL

Advancements in conversational agents and NL2SQL frameworks have enabled end users to interact with databases using natural language through messaging applications, voice interfaces, and various client devices. These systems leverage LLMs and prompt-driven workflows to translate natural language utterances into executable queries in different programming languages (e.g., SQL), often relying on database schema information and contextual chat history. As agents become more capable of handling complex, multi-turn conversational workflows that include schema resolution, query generation, execution, and validation, there is an increased need for robust training data that reflects realistic, context-dependent interactions. The present application addresses this need by providing systems and methods for generating context-aware, multi-turn natural language to SQL training data that improves the effectiveness and reliability of NL2SQL models within agent-based environments. By supporting the automatic creation and validation of linked sequences of user queries and corresponding SQL statements, the described approaches enhance the ability of the agent to manage evolving dialogs, resolve ambiguities, and adapt to user feedback. This facilitates a more accurate and contextually appropriate response in practical database interaction scenarios.

Although the description below is directed towards database query languages like SQL, it should be understood that the methods and techniques described herein may be applied to other query languages such as PGQL, logical database queries, API query languages (e.g., GraphQL, REST) and so forth. To do so, modifications specific to the query language used may be made to the prompt used by the generative model that do not go beyond the scope of the present disclosure.

Throughout this disclosure, the terms “SQL Query” and “SQL Queries” are used to describe a structured command or statement written in Structured Query Language (SQL) that is used to retrieve, manipulate, or manage data within a relational database. However, referencing SQL queries in this disclosure should not be considered limiting, and any suitable equivalent, including queries written in equivalent and/or similar languages or systems that perform equivalent and/or similar data operations, is anticipated within the scope of this disclosure.

Throughout this disclosure, the term “Natural Language query” or “Natural Language Utterance” is used to describe a spoken, signed (e.g., American/French/British Sign Language, etc.), or written expression in a human language, that conveys a user's intention or query and can be processed or interpreted by computational systems for tasks like translation, information retrieval, or conversational AI. However, this definition should not be considered limiting, and any suitable equivalent, including alternative forms of human language and/or equivalent machine language (or code) input or communication, is anticipated within the scope of this disclosure. In some instances, the natural language utterance includes complex reasoning such as arithmetic computation, commonsense inference, temporal normalization, counterfactual reasoning, and/or multilingual tasks.

### Technical Challenges

Despite recent advances in NL2SQL and conversational AI, the development of robust database query models remains limited by the absence of high-quality, context-aware multi-turn datasets. Existing training resources primarily focus on single-turn interactions, in which each natural language query is independent and does not build upon prior dialog. As a result, models trained on these datasets lack the ability to track, interpret, and incorporate conversational context, leaving them ill-equipped to handle the iterative, reference-rich exchanges that characterize practical user interactions with databases.

A persistent technical challenge in NL2SQL modeling is ensuring that automatically generated SQL queries are both syntactically valid and semantically correct, and that they reliably conform to the structure and constraints of the target database schema. Current pipelines rarely simulate the iterative process of error detection and correction that occurs in real-world usage, and lack robust mechanisms for integrating execution feedback and user-driven revisions into the training loop. Manual review is impractical for large datasets, while existing automated approaches struggle to provide reliable, context-sensitive validation and correction.

Finally, ensuring diversity and configurability in the types of follow-up queries present in training data presents a technical hurdle. Developers often require datasets that emphasize particular interaction pattern, such as referential, filtering, or modifying follow-ups, to target domain-specific needs or known weaknesses in model performance. Conventional data generation pipelines lack the flexibility to control the distribution, structure, or dependency patterns among generated queries, making it difficult to tailor training data to specific applications or maintain balanced coverage across different conversational scenarios. Collectively, these challenges underscore the need for a comprehensive data generation and validation framework capable of producing high-quality, diverse, and contextually accurate multi-turn NL2SQL training data at scale.

### Technical Solutions

The present application addresses the aforementioned challenges by leveraging a multi-turn NL2SQL data generation pipeline designed to generate high-quality, contextually rich natural language and SQL training data for conversational database agents. The pipeline integrates advanced natural language generation, prompt-driven control, contextual rewriting, dual validation, and feedback-driven error correction in a process that enables the creation of datasets reflecting the complexities of multi-turn user interactions. The resulting data may support the training and evaluation of NL2SQL models for use in practical, production environments.

An important technical advancement of the present application is the generation of context-aware, multi-turn sequences of natural language queries that closely mimic authentic user interactions with a database system. Using generative models (e.g., LLMs), the pipeline produces follow-up questions that reference prior conversation turns, enabling the inclusion of referential, filtering, and modifying queries that are important for modeling realistic dialog flows. The process is further enhanced by prompt-driven trajectory control, which allows explicit specification or randomization of conversational dependency patterns, thereby ensuring that generated data covers a broad range of interaction types. The system further applies contextual query rewriting, wherein each follow-up query is rewritten to be self-contained by incorporating relevant information from prior conversation turns. This approach allows each query to be processed by single-turn NL2SQL models without requiring modifications to model architecture.

The pipeline further includes schema-aware SQL query generation and in-context learning (ICL) example retrieval. SQL generation is performed using prompts that incorporate the database schema, which may ensure that generated queries reflect the structure and constraints of the underlying database and avoid referencing nonexistent tables or columns. The retrieval of semantically relevant NL-SQL pairs from seed data as in-context examples may improve the accuracy of SQL generation, particularly for complex or novel queries. These features may enhance the quality of the generated training data and support the effectiveness of subsequent validation and correction steps.

Another important feature is that generated SQL queries are validated using a dual validation mechanism that includes a database execution validation and a checklist-based evaluation by a judge LLM. This dual validation ensures that only executable, logical SQL queries are retained, with both execution errors and semantic discrepancies systematically identified. The output reports generated by this validation process are then incorporated into an iterative correction and refinement loop, wherein candidate SQLs are revised based on execution feedback and checklist scores until all criteria are met or a maximum number of attempts is reached. Also implemented into the iterative refinement loop are simulated error feedback and user feedback. These simulations incorporate realistic error cases and user-driven corrections into the prompt of the generative model performing the iterative refinements, exposing models to both successful and erroneous interactions. This not only enhances the robustness and adaptability of NL2SQL models in handling real-world, multi-turn dialog, but also teaches them to recover from failure.

### Overview of a Multi-Turn NL2SQL Date Augmentation Pipeline

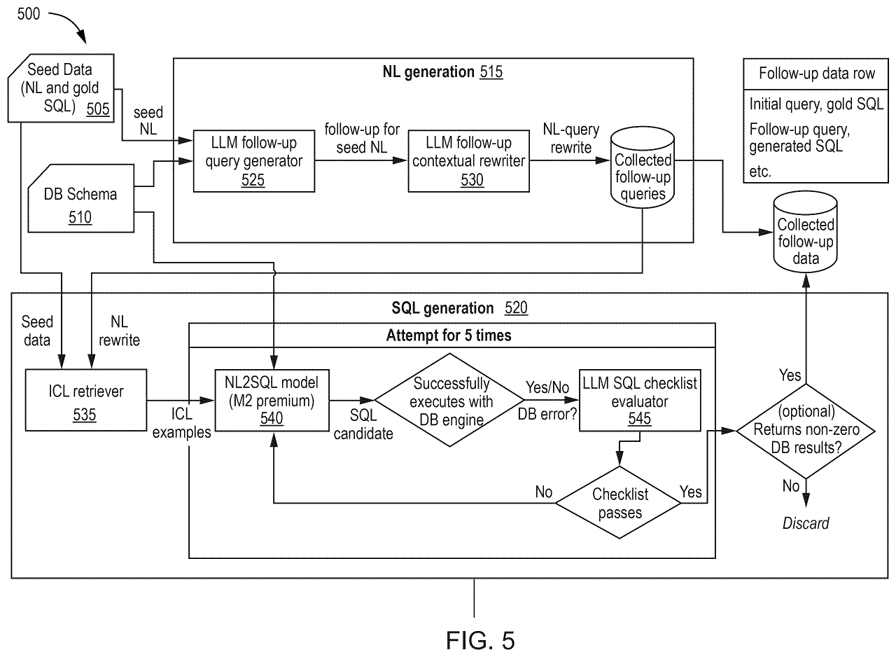

FIG. 5 shows an example multi-turn NL2SQL data augmentation pipeline 500 (referred to herein as pipeline 500), configured to generate and validate multi-turn natural language to SQL data. The multi-turn natural language to SQL data may then be used to fine-tune a generative model for multi-turn tasks. Pipeline 500 can be implemented using software only, hardware only, firmware only, or any combination of hardware, software, and/or firmware. As shown in FIG. 5, pipeline 500 receives as input seed data 505, which may include natural language queries and corresponding gold SQL, and a database schema 510. Pipeline 500 comprises two processes, which may be executed in parallel, in sequence, or in a distributed arrangement across multiple computing resources, or as a combination thereof. The first process is a natural language query generation process 515, which leverages one or more generative models (e.g., LLMs) for tasks including follow-up query generation and contextual rewriting of queries. The second process is an SQL query generation process 520, which also leverages one or more artificial intelligence (AI) models (e.g., embedding models, natural language to query models, LLMs, and the like) for tasks including retrieval of in-context learning (ICL) examples, natural language to query generation, query validation, and query refinement. The natural language query generation process 515 and the SQL query generation process 520, as well as their constituent components, may be executed by one or more processes, threads, or programs implemented in software, hardware, and/or firmware within a computing system (e.g., as described with respect to FIGS. 7-11).

The process begins with seed data 505 which includes natural language query and gold-standard SQL statement pairs. In some instances, seed data 505 is single-turn natural language query and gold-standard SQL statement pairs. The seed data 505 may be obtained from one or more sources, including annotated public datasets, proprietary corpora, or manually curated datasets prepared by subject matter experts. Additionally, seed data 505 may be verified for syntactic and semantic correctness, as well as for coverage of diverse query types and schema elements. The database schema 510 provides a formal definition of the structure of the target database, specifying the organization and relationships among tables, columns, data types, and keys. Within pipeline 500, the database schema 510 provides context for both the generation and validation of natural language queries and their corresponding SQL statements. It is utilized to ensure that generated queries reference valid tables and columns, adhere to the defined relationships and constraints, and are executable within the actual database environment. The database schema 510 is the foundational reference for aligning seed data 505, guiding follow-up query generation, enabling contextual rewriting, and constraining the SQL synthesis and validation processes so that all generated data remains consistent with the real structure and logic of the underlying database system.

The natural language query generation process 515 is a computational system or algorithmic workflow configured to generate contextually relevant, multi-turn natural language queries to improve performance of NL2SQL models on real-world multi-turn user interactions. Process 515 may be implemented as one or more generative models (e.g., LLMs), neural network architectures (e.g., transformer-based models), or any suitable combination of machine learning and rule-based components. For example, in some configurations, process 515 may comprise a single generative model (e.g., LLM) configured to generate follow-up natural language utterances and to rewrite those utterances to incorporate relevant conversational context. This single model configuration may be achieved by modifying the prompts provided to the generative model to specify the particular generation or rewriting task required. In alternative embodiments, process 515 may include multiple generative models operating in sequence or in parallel. For instance, one model may be dedicated to generating follow-up natural language utterances based on an initial seed query and schema, while a separate model may be responsible for rewriting these follow-up utterances to produce self-contained, contextually complete natural language utterances. These examples are merely illustrative, and other configurations, architectures, or processing sequences may be contemplated depending on system requirements or deployment constraints. The natural language query generation process 515 may operate as a standalone module within the overall pipeline, or it may be integrated with, or operate in conjunction with, other components such as SQL query generation 520, validation, or feedback modules.

As shown in FIG. 5, a follow-up query generator model 525 (referred to herein as generator 525) receives as input the seed data 505 (comprising natural language queries and corresponding SQL statements) and the database schema 510. In addition, generator 525 may further receive a proposed follow-up trajectory comprising sequences of follow-up question types that define the logical structure and progression of a multi-turn dialog. This trajectory may be selected from a pre-compiled set of logically consistent follow-up types (see Table 2), which may be chosen at random to encourage generalization, or specified explicitly to target particular interaction patterns or test cases. In some embodiments, the pre-compiled set of logically consistent follow-up question types may include, without limitation, referential queries (which draw upon information or entities from earlier turns), filtering queries (which add constraints or narrow the scope of prior results), and modifying queries (which alter the focus or criteria of earlier queries). The system is designed to be extensible, allowing for the addition of new follow-up patterns and types as needed to address evolving use cases or domain requirements. This extensibility ensures that the generated multi-turn dialogs are robust, contextually grounded, and representative of real-world database interactions. Additionally, the integration of a follow-up trajectory improves the diversity of generated follow-up questions and reduces model hallucinations. For each generated follow-up query, generator 525 assigns a dependency type tag reflecting its relationship to previous conversation turns; these tags are output together with the follow-up queries to provide structural and contextual information for downstream processing. The selection and application of a follow-up trajectory directly influence the composition and sequence of the generated follow-up queries. Example 1 below provides a representative prompt and output structure illustrating this process.

TABLE 2

| Test Type | Definition | Example |
|---|---|---|
| Referential- | Questions refer to previous | Revising questions (can be columns from the same |
| Question | questions in the | table or cross-table references): |
| | conversation. | Turn 1: Show all flights to New York. |
| | | Turn 2: Include their departure times. |
| Referential- | Questions refer to previous | Using previous execution results: |
| Results | execution results in the | Turn 1: Find the total number of flights per airline |
| | conversation. | Turn 2: What are the destinations for the first airline |
| | | in the above list? |
| Filtering | Questions narrow the | Using previous execution results: |
| | previous question's scope | Turn 1: Find the total number of flights |
| | by adding conditions but | Turn 2: Include only the flights to Australia |
| | without modifying any | Turn 1: Find the total number of flights |
| | existing condition filtering | Turn 2: Include only the flights to Australia |
| | values. | |
| Modifying | Questions mention | Adding constraints to narrow results: |
| | altered conditions and | Turn 1: Find the diagnoses for patients over 60 years |
| | omit all the same | Turn 2: How about for male patients younger than |
| | conditions in the previous | 40 sorted alphabetically? |
| | context and define new | |
| | conditions. | |
| Database | Feedback from DB engine | Error feedback from DB engine for non-executable |
| Execution | that produces any SQL | SQLs: |
| Errors | engine error message when | Turn 1: Find the total number of flights per airline |
| | the predicted SQL is | Turn 2: Here is the error message: ″No such |
| | executed. | column: airline_name.″ Can you revise the SQL |
| | | query? |
| User | Feedback from user as a | Error feedback from the user when SQL is incorrect: |
| Feedback | comment or advice from | Turn 1: Find the total number of flights per airline |
| | the user to help the model | Turn 2: No, I asked to return totals per airline. Not |
| | revise its SQL prediction. | the total flights overall. |
| | Here, the SQL logic is | Turn 3: To correct the SQL query, follow these |
| | incorrect and does not | steps: 1. Instead of selecting all columns using |
| | answer the NL. | ‘ SELECT *‘ , specify only the column that contains |
| | In the cases where the user | the airline names, which is ‘ Airline‘ . 2. Use the |
| | may have a different | ‘ DISTINCT‘ keyword to fetch only unique airline |
| | intention than specified in | names and avoid duplicates. |
| | the original NL, this falls | |
| | under Follow-up: Modifying. | |

Each follow-up query generated by generator 525 is contextually linked to prior conversation turns, either through implicit or explicit references, the use of pronouns, or other Logical dependencies. This approach ensures that the resulting sequence of queries accurately reflects the natural flow and complexity of real-world user interactions with a database system. The tagging of dependency types for each follow-up query provides a structural framework that supports downstream processing, including contextual rewriting, SQL generation, and dialog evaluation. These annotations facilitate the creation of rich, contextually grounded datasets that are particularly well-suited for the training, development, and evaluation of multi-turn text-to-SQL systems.

Example 1 below presents a representative prompt that may be used with generator 525 for follow-up query generation. This example is provided for illustrative purposes only and is not intended to limit the scope of the claimed embodiments. One of ordinary skill in the art will appreciate that a variety of prompt structures, annotation schemes, and generation workflows may be implemented, all of which are fully contemplated by the present disclosure.

### ExampLe 1: LLM Prompt for Follow-Up Query Generation

Prompt
**Generating Contextual Follow-up Questions**
You are a helpful assistant tasked with generating **contextual follow-up questions** for a text-
to-SQL task. Your goal is to produce a series of follow-up natural language (NL) questions based
on:

| | |
|---|---|
| 1. | A database schema (a sequence of CREATE TABLE statements). |
| 2. | A **seed NL query**. |
| 3. | A **sample proposed test type annotation flow** to guide the structure and balance of |
| | the generated follow-ups. Generate the follow-ups to match the dependency types in |
| | each turn from the provided flow. Do not exceed the number of turns than what is |
| | provided in the flow. |

### **Dependency Test types (Detailed):**
#### **[0] Independent Questions**
**Definition:** Stand-alone queries that do not depend on any prior context. They can be
understood and resolved without referencing earlier questions.
**Examples:**
Q1: “List all employees hired in 2023.” [0] ( )
Q2: “Show all departments in the company.” [0] ( )
---
#### **[1] Referential Follow-ups**
**Definition:** Questions that **build on previous queries** by requesting additional details,
such as adding columns or expanding results (e.g., extending the ‘ SELECT’ clause).
**Key Requirements:**
Explicit reference to earlier turns is absent; the follow-up relies on pronouns or implicit context.
Cannot stand alone due to lack of context (e.g., *“What are their salaries?”*).
**Examples:**
Q1: “List all employees hired in 2023.” [0] ( )
Q2: “What are their salaries?” [1] (Q1)
Q1: “Show all departments in the company.” [0] ( )
Q2: “How many employees are in each?” [1] (Q1)
---
#### **[2a] Filtering Follow-ups (Immediate)**
**Definition:** Narrow the scope of the **immediate prior query** by adding filters (‘ WHERE’
clause), revising results (‘ GROUP BY’, ‘ ORDER BY’ ), or limiting rows (‘ FETCH’, ‘ RANK’,
‘ PARTITION BY’ , etc.).
**Key Requirements:**
Must depend directly on the immediate prior turn for meaningful execution.
Filtering conditions must add new constraints or refine the results.
**Examples:**
Q1: “List all employees hired in 2023.” [0] ( )
Q2: “Show only those in the IT department.” [2a] (Q1)
Q1: “Show all employees earning above $100,000.” [0] ( )
Q2: “Rank them by hire date.” [2a] (Q1)
---
#### **[2b] Filtering Follow-ups (Non-immediate)**
**Definition:** Narrow the scope of the **immediate prior query** by adding filters (‘ WHERE’
clause), revising results (‘ GROUP BY’ , ‘ ORDER BY’), or limiting rows (‘ FETCH’ , ‘ RANK’,
‘ PARTITION BY’ , etc.), but narrow the scope of a query from **non-immediate history** by
adding filters or revising the results. These depend on queries earlier than the immediate prior
turn.
**Key Requirements:**
Must explicitly reference results or context from an earlier turn.
**Examples:**
Q1: “List all employees hired in 2023.” [0] ( )
Q2: “What are their salaries?” [1] (Q1)
Q3: “Filter for those earning above $100,000.” [2b] (Q1, Q2)
Q1: “Show all employees in the IT department.” [0] ( )
Q2: “What are their managers' names?” [1] (Q1)
Q3: “How many were hired this year?” [2b] (Q1)
---
#### **[3] Modifying Follow-ups**
**Definition:** Queries that significantly **change the focus or logic** of prior queries while still
depending on implicit references to them. These omit prior SQL logic and replace it entirely but
cannot be understood and cannot be translated into SQL without the earlier context.
**Key Requirements:**
Must implicitly refer to prior filtering conditions or results.
Should redefine the scope or criteria while retaining a dependency on earlier turns.
**Examples:**
Q1: “List all employees hired in 2023.” [0] ( )
Q2: “How about those hired earlier?” [3] (Q1)
Q1: “Show all departments in the company.” [0] ( )
Q2: “Focus on the ones with more than 50 employees.” [3] (Q1)
---
### Instructions for Follow-up Question Generation:

| 1. | **Use Contextual References**: | |
|---|---|---|
| | - | Ensure every follow-up question implicitly references the context of previous |
| | | questions using pronouns, deictic terms, or connecting phrases. |
| | - | Do not explicitly repeat conditions from prior questions unless the context demands |
| | | it. |
| 2. | **Follow the Proposed Test Type Flow**: | |
| | - | Use the provided **sample proposed test type annotation flow** to guide the |
| | | sequence and dependency structure of the follow-ups. |
| | - | Ensure the generated follow-ups match the balance and type coverage indicated in |
| | | the sample flow. |
| 3. | **Annotations and Dependencies**: | |
| | - | Each follow-up question must include: |
| | - | A **ranked list of test type annotations** (e.g., ‘ [2a, 1]’ ) indicating the test types |
| | | applied. |
| | - | A **list of required question identifiers** (e.g., ‘ Q1’ ) to show which prior queries are |
| | | necessary for resolving contextual references. |
| 4. | **Prohibited Actions**: | |
| | - | Do not assume or introduce external knowledge outside of DB schema. |
| | - | Do not include irrelevant or redundant details. |
| | - | Do not ask for the same details which are already included (implicitly or explicitly, |
| | | e.g., “Who are the employees...?” → “What are their names?”, this is redundant) in |
| | | previous questions. |
| | - | Do not ask for any missing, non-existent columns in DB schema. |
| | - | Ensure all follow-up questions are **meaningful, natural, answerable and executable |
| | | against the provided schema**. |
| | - | Do not provide any additional commentary or explanation. |
| | - | Ensure diversity in writing styles and vary on how specific or generic the questions are |
| | | to mimic a real-world user questions. |

### **Output Format:**
‘‘‘plaintext
Q1: <follow-up question> [<comma-separated test type numbers>] (<comma-separated
dependency identifiers>)
Q2: <follow-up question> [<comma-separated test type numbers>] (<comma-separated
dependency identifiers>)
...
Q<N>: <follow-up question> [<comma-separated test type numbers>] (<comma-separated
dependency identifiers>)
’’’
### Example Scenarios:
------
Q1: Any reported crimes in the last 5 years sorted by date? [0] ( )
Q2: Where were these reported at from the top 2? [0] ( )
Q3: Find the least frequent crimes from the above cities. [3] (Q2)
Q4: What is the subcategories of those crimes? [2a, 1] (Q3)
Q5: From the locations we found above, how many of them are from the US? [2a] (Q2)
------
Q1: Who scored the highest in Maths? [0] ( )
Q2: What was their score on English? [3] (Q1)
------
Q1: Find patients older than 60. [0] ( )
Q2: Find all diagnoses related to heart failure. [0] ( )
Q3: Filter that list for the above patient group. [2b, 2c] (Q1, Q2)
Q4: Include the visit dates along with the patient names. [1] (Q3)
Q5: Filter those by who were diagnosed with diabetes. [2a] (Q4)
-----
Q1: Find all diagnoses of patients above 60. [0] ( )
Q2: How about for male patients younger than 40? [3] (Q1)
Q3: Find the treatments provided during hospital visits for them. [3] (Q2)
Q4: Filter both patient cohorts for those who were diagnosed with heart failure. [2c, 3] (Q1, Q2)
-----
Q1: What are the case details for all civil lawsuits filed in 2024? [0] ( )
Q2: And criminal lawsuits? [3] (Q1)
-----
Q1: What courses are available for students majoring in Computer Science? [0] ( )
Q2: Can you also list the prerequisites for each? [1] (Q1)
Q3: How about Maths? [3] (Q1, Q2)
-----
Q1: What is the average grade of students in the Maths department? [0] ( )
Q2: List all the students who participated in sports activities in 2023 [0] ( )
Q3: Can you recalculate the average only for them? [2b] (Q1, Q2)
-----
BEGIN!
### Input:
‘‘‘plaintext
Database Schema:
{db_schema}
Seed NL Query:
{initial_question}
Sample Proposed Test Type Annotation Flow:
{dep_flow}
’’’
### **Output.**
Q1: {initial_question} [0] ( )
Inputs:
CREATE TABLE “ShS”.airlines (
“uid” INTEGER NOT NULL,
“Airline” VARCHAR(4000 CHAR),
abbreviation VARCHAR(4000 CHAR),
country VARCHAR(4000 CHAR),
CONSTRAINT uid_pk_0 PRIMARY KEY (“uid”)
);
CREATE TABLE “ShS”.airports (
city VARCHAR(4000 CHAR),
airportcode VARCHAR(4000 CHAR) NOT NULL,
airportname VARCHAR(4000 CHAR),
country VARCHAR(4000 CHAR),
countryabbrev VARCHAR(4000 CHAR),
CONSTRAINT airportcode_pk_1 PRIMARY KEY (airportcode)
);
CREATE TABLE “ShS”.flights (
“Airline” INTEGER NOT NULL,
flightno INTEGER NOT NULL,
sourceairport VARCHAR(4000 CHAR),
“destairport” VARCHAR(4000 CHAR),
CONSTRAINT airline_flightno_pk_2 PRIMARY KEY (“Airline”, flightno),
CONSTRAINT destairport_fk_0 FOREIGN KEY(“destairport”) REFERENCES SHS.airports
(airportcode),
CONSTRAINT sourceairport_fk_1 FOREIGN KEY(sourceairport) REFERENCES SHS.airports
(airportcode)
);
Seed NL: “List the airport that have flights arriving from more than 5 different airports”
Suggested dependency flow: [Independent, Referential, Filtering (immediate), Modifying]
Outputs:
Q1: List all flights with their source and destination airport names [Independent] ( )
Q2: What are the airline names for these flights? [Referential] (Q1)
Q3: Filter the results to show only flights from the US. [Filtering (immediate)] (Q1, Q2)
Q4: How about flights to countries other than the US? [Modifying] (Q1, Q2, Q3)

Following generation and dependency tagging by generator 525, each multi-turn follow-up query is provided to a contextual rewriter model 530 (referred to herein as rewriter 530). The rewriter model 530 transforms each follow-up query into a “self-contained” query by incorporating all necessary contextual elements from the previous dialog. As used herein, a “self-contained” query expressly incorporates all contextual information required for its independent interpretation and subsequent processing, such that its intended meaning and operative details are ascertainable solely from the text of the query itself, without reference to any prior conversational turns or external conversational state.

To accomplish this, rewriter 530 receives both the current follow-up query and the previous conversational history. It then integrates relevant contextual elements (e.g., entities, filtering conditions, parameters, or prior results) that would otherwise be implicitly derived from earlier exchanges. This process includes resolving pronouns, deictic expressions, and other referential language to their specific antecedents, thereby eliminating ambiguity and ensuring that the user's intent is fully and unambiguously conveyed within the query text. The output of rewriter 530 is thus a stand-alone, self-contained query that can be interpreted and executed without any reliance on prior conversational context. These rewritten queries may be collected and stored for further processing within pipeline 500, including for use with single-turn NL2SQL models. By way of example, given the conversational history:
1. “List all flights with their source and destination airport names.”
2. “What are the airline names for these flights?”
3. “Filter the results to show only flights from the US.” and
Follow-up query: “How about flights to countries otherthan the US?”,
Rewriter 530 would generate: “List flights with their source and destination airport names, including airline names, where the source airport is in the US and the destination airport is outside the US.”

An exemplary prompt for rewriter 530 is shown in Example 2 below. The example demonstrates how the system instructs rewriter 530 to rewrite a context-dependent follow-up query into a fully self-contained form using only information present in the conversation history. This example is provided for illustrative purposes only and is not intended to limit the scope of the claimed embodiments. One of ordinary skill in the art will appreciate that a variety of prompt structures, annotation schemes, and rewriting workflows may be implemented, all of which are fully contemplated by the present disclosure.

### Example 2: Prompt for the LLM Contextual Rewriter

Prompt:
You are an assistant specialized in rewriting queries. Your task is to rewrite the current query in a
conversation so that it is fully self-contained. This means incorporating all relevant context from
the prior conversation to ensure the rewritten query makes sense independently.
## Guidelines:

| | |
|---|---|
| - | Include only the necessary context from the previous conversation that is relevant to the |
| | current query. |
| - | Avoid including irrelevant or redundant details; focus on clarity and conciseness. |
| - | Preserve the original intent and meaning of the current query. |
| - | Use exclusively the information provided in the conversation history; do not introduce |
| | external knowledge, assumptions, or details not explicitly mentioned. |
| - | Ensure the rewritten query can be understood and executed without needing additional |
| | context. |
| - | Provide only the rewritten query as the output-no commentary or explanations. |

## Input Format:
- Conversation History: A list of previous queries.
- Current Query: The latest user query to be rewritten.
## Output Format:
- Rewritten Query: A fully self-contained version of the current query.
BEGIN!
Conversation History:
{conversation}
Current Query:
{followup}
Rewritten Query:
Inputs:
Previous user queries:

| | |
|---|---|
| ∘ | List all flights with their source and destination airport names. |
| ∘ | What are the airline names for these flights? |
| ∘ | Filter the results to show only flights from the US. |

Current follow-up user query to be rewritten: “How about flights to countries other than the US?”
Outputs:
List flights with their source and destination airport names, including airline names, where the
source airport is in the US and the destination airport is outside the US.

The SQL query generation process 520 is a computational workflow that synthesizes SQL statements from the self-contained, multi-turn natural language queries produced by the previous contextual rewriting step. Process 520 may be implemented using one or more artificial intelligence models, generative models, or any suitable combination of machine learning and rule-based components. For example, in some configurations, process 520 may comprise: (i) an embedding model for retrieval of in-context learning (ICL) examples, (ii) a natural language to query model (e.g., NL2SQL model) that translates text to queries, and (iii) one or more generative models (e.g., LLMs) for query validation and/or refinement. In certain implementations, the same or different AI models may be used for both natural language query generation (process 515) and SQL query generation (process 520), depending on system requirements or deployment constraints. These examples are merely illustrative, and other configurations, architectures, or processing sequences may be contemplated depending on system requirements or deployment constraints. The SQL query generation process 520 may operate as a standalone module within the overall pipeline, or it may be integrated with, or operate in conjunction with, other components such as natural language query generation process 515, validation, or feedback modules.

In certain embodiments, the ICL retriever 535 is implemented as an embedding model, leveraging advanced machine learning architectures to enhance retrieval performance. The embedding model encodes the rewritten natural language utterances generated by the pipeline, as well as the natural language utterances present in the seed data 505, into numerical vector representations in a high-dimensional semantic space. By encoding both the current rewritten natural language utterance (i.e., the input query for which SQL is to be generated) and candidate natural language utterances from the seed data 505, the ICL retriever 535 can efficiently compute semantic similarity between these representations. This enables the ICL retriever 535 to identify and retrieve the most relevant in-context examples from the dataset, ensuring that the selected ICL examples from the seed data 505 closely reflect the logical and semantic intent of the rewritten queries. Representative embedding models suitable for this purpose include, but are not limited to, all-MiniLM, BERT, RoBERTa, General Text Representation (GTR), Universal Sentence Encoder (USE), and Language-agnostic BERT Sentence Embedding (LaBSE). These models may be trained to capture nuanced semantic relationships between textual inputs, providing a robust foundation for context-aware retrieval in both natural language processing and program synthesis tasks.

By retrieving contextually relevant examples, ICL retriever 535 ensures that candidate SQLs generated by the NL2SQL model 540 are more likely to align with the user's intended query logic. The process for selecting in-context examples is based on measures of semantic similarity between the rewritten natural language utterance (i.e., the current query generated) and the natural language utterances found in the seed data 505. Semantic similarity can be established through several methods known in the art. For example, embedding-based similarity may be employed, where both the rewritten natural language utterance and each candidate seed data natural language utterance are encoded as high-dimensional vectors using a language model or domain-specific encoder. Similarity scores (e.g., cosine similarity or dot product) are then computed between the vector representing the rewritten query and each vector representing a seed data utterance, to identify those ICL examples whose semantic content most closely matches the current query. Additional approaches include intent and structure matching (classifying queries by their logical operation (e.g., aggregation, filtering, joining) or by structural features (e.g., SUM, GROUP BY)) and leveraging domain or schema context to filter or rank candidates. In typical implementations, the top-ranked examples (such as the five most similar pairs) may be incorporated into the NL2SQL model 540 prompt to maximize contextual relevance and optimize input length. Example 3 below illustrates the use of embeddings for ICL retrieval, showing both input queries and the selected contextual examples

### Example 3: Extraction of In-Context Learning Examples Using Embeddings

Description: Sentence embedding model: all-MiniLM-L6-v2
Inputs:
Seed NL: List all flights with their source and destination airport names
Current Query: What are the airline names for these flights?
Outputs:
User: List all flights with their source and destination airport names
Assistant: SELECT f.“FLIGHTNO” AS “Flight Number”, sa.“AIRPORTNAME” AS “Source Airport”,
da.“AIRPORTNAME” AS “Destination Airport” FROM “ShS”.“FLIGHTS” f JOIN “ShS”.“AIRPORTS” sa
ON f.“SOURCEAIRPORT” = sa.“AIRPORTCODE” JOIN
“ShS”.“AIRPORTS” da ON f.“destairport” = da.“AIRPORTCODE”
User: List the airports that have flights arriving from more than 5 different airports
Assistant: SELECT “a”.“AIRPORTNAME”, COUNT(DISTINCT “f”.“SOURCEAIRPORT”) AS
“NumOfSourceAirports” FROM “ShS”.“ AIRPORTS” “a” JOIN “ShS”.“FLIGHTS” “f” ON
“a”.“AIRPORTCODE” = “f”.“destairport” GROUP BY “f”.“destairport” , “a”.“ AIRPORTNAME”
HAVING COUNT(DISTINCT “f”.“SOURCEAIRPORT”) > 5

In some instances, ICL retriever 535 may not identify any suitable gold-standard in-context examples within the seed data 505, such as when semantic similarity thresholds are not met or no relevant training instances exist. In such cases, the system omits the ICL retrieval step from the workflow. As a result, NL2SQL model 540 and subsequent components receive only the rewritten natural Language query, previous without additional contextual conditioning. This strategy helps safeguard candidate SQL generation from the influence of irrelevant or misleading context. In certain implementations, fallback mechanisms (e.g., default prompt templates or heuristic context) may be employed to further mitigate the absence of in-context examples. This design ensures that the pipeline remains robust and effective even in domains or scenarios with limited training data or rapidly evolving schema.

Following retrieval of in-context examples, the selected in-context examples (if any are available), the rewritten natural language query produced by the contextual rewriting model 530, and the relevant database schema 510 are collectively provided as input to the NL2SQL model 540. The NL2SQL model 540 may be any text-to-SQL transformation model, including but not limited to sequence-to-sequence neural networks, large language models, or hybrid systems, and is not restricted to any particular modeling technique or implementation. In certain embodiments, the NL2SQL model 540 is a single-turn model (e.g., M2 premium model) which processes each rewritten natural language query independently, without retaining conversational context across turns. The inclusion of in-context examples retrieved from the seed data 505 further conditions the NL2SQL model by providing semantically similar NL-SQL pairs as part of the model prompt, thereby increasing the likelihood of generating syntactically and semantically correct SQL statements aligned with the user's intent. An illustrative prompt and corresponding output for this step are provided in Example 4 below.

### Example 4: Prompt Given to a Text-to-SQL Model

Prompt:
Given a question, create a correct Oracle SQL query.

| | |
|---|---|
| - | Use only the specified tables from the schema context and make sure that columns in |
| | the query are in the right tables. |
| - | If a database object uses a quoted identifier with double quotation marks (″), then you |
| | must use the double quotation marks whenever you refer to that object in the Oracle |
| | SQL. |
| - | Only use the tables listed below. |
| - | If the table definition includes the table owner, you should include both the owner name |
| | and user-qualified table name in the Oracle SQL. |

Here is the schema context:
{db_schema}
Instructions:
Write an Oracle SQL query to address the above question. Ensure the query is valid for Oracle
Database. Only produce SQL.
{icl_example_list}
Question: {rewritten_user_query}
Oracle SQL:
Inputs:
Rewritten query: List the names of all airports that have no flights departing from them.
Seed NL: List all airports that have no flights departing from them.
Follow-up query: What are the names of these airports?
ICL Examples:
User: List all flights with their source and destination airport names
Assistant: SELECT f.“FLIGHTNO” AS “Flight Number”, sa.“AIRPORTNAME” AS “Source Airport”,
da.“AIRPORTNAME” AS “Destination Airport” FROM “ShS”.“FLIGHTS” f JOIN “ShS”.“AIRPORTS” sa
ON f.“SOURCEAIRPORT” = sa.“AIRPORTCODE” JOIN
“ShS”.“AIRPORTS” da ON f.“destairport” = da.“AIRPORTCODE”
User: List all flights that fly from one airport to another within the same country
Assistant: SELECT f.“FLIGHTNO” AS “FlightNumber”, f.“SOURCEAIRPORT” AS “SourceAirport”,
f.“destairport” AS “DestinationAirport”, a1.“COUNTRY” AS “Country” FROM “ShS”.“FLIGHTS” f
JOIN “ShS”.“AIRPORTS” a1 ON f.“SOURCEAIRPORT”
= a1.“AIRPORTCODE” JOIN “ShS”.“AIRPORTS” a2 ON f.“destairport” = a2.“AIRPORTCODE”
WHERE a1.“COUNTRY” = a2.“ COUNTRY”
Outputs:
SELECT a.“AIRPORTNAME” FROM “ShS”.“AIRPORTS” a LEFT JOIN “ShS”.“FLIGHTS” f ON
a.“AIRPORTCODE” = f.“ SOURCEAIRPORT” WHERE f.“SOURCEAIRPORT” IS NULL

After candidate SQL statements are generated by the NL2SQL model 540, they are subjected to a dual validation process designed to assess their quality and reliability. The first stage, execution-based validation, is performed using a database engine 543 configured to execute candidate queries against the specified database schema 510. The database engine 543 may be realized as any suitable database platform (e.g., Oracle Database, PostgreSQL, MySQL, SQLite), and may be deployed as a standalone service, part of an integrated environment, or in the cloud. Candidate SQL statements are executed, and detailed execution reports are output, indicating success or failure and providing diagnostic information (e.g., syntax issues, logical inconsistencies, constraint violations, and the like) or error messages as appropriate. These execution reports may be further augmented with user-friendly explanations and structured hints. Any candidate SQLs that fail the execution-based validation are retained as feedback for the iterative refinement process described below. Example 5 provides an illustrative scenario of this validation step. The results of execution-based validation are then complemented by a second stage of checklist-based evaluation, as described in the following section.

### Example 5: Database Execution on Oracle Database

Inputs:
SQL candidate: SELECT a.“AIRPORTNAME” FROM “ShS”.“AIRPORTS” a LEFT JOIN
“ShS”.“FLIGHTS” f ON a.“AIRPORTCODE” = f.“SOURCEAIRPORT” WHERE f.“SOURCEAIRPORT” IS
NULL
Outputs:
Execution Results:
[{‘AIRPORTNAME’: ‘Aberdeen Regional Airport’},
{‘AIRPORTNAME’: ‘Logan International Airport’},
{‘AIRPORTNAME’: ‘Denver International Airport’},
{‘AIRPORTNAME’: ‘Detroit Metropolitan Wayne County Airport’},
{‘AIRPORTNAME’: ‘Dyess Air Force Base’},
{‘AIRPORTNAME’: ‘Minneapolis-Saint Paul International Airport’},
{‘AIRPORTNAME’: ‘Philadelphia International Airport’},
{‘AIRPORTNAME’: ‘Seattle-Tacoma International Airport’}]
Execution Errors = ‘Successfully executes'

The second stage of the dual validation process is an evaluation-based validation process where the candidate queries are evaluated by a judge LLM (i.e., the LLM SQL checklist evaluator 545; referred to herein as LLM evaluator 545). The LLM evaluator 545 is configured to act as an impartial judge by applying one or more evaluation methodologies to the candidate SQL statements. For example, in some embodiments, the LLM evaluator 545 may employ a checklist-based scoring methodology, and/or in addition to or in alternative of, the LLM evaluator 545 may utilize exact matching, fuzzy matching, or other assessment techniques. The LLM evaluator 545 receives as input the candidate SQL statements, their corresponding rewritten natural language utterances, the database schema 510, and a prompt defining the evaluation protocol or criteria (see Example 7 below).

In certain embodiments, the checklist-based methodology is applied, wherein the candidate SQL statements are assessed against a configurable set of categories or criteria. Each criterion may target a specific aspect of SQL correctness, such as intent alignment, required columns, filtering, logical fidelity, table joins, and schema compliance. Criteria may also cover advanced SQL(features, output format, and optimization (see Example 6 below for a detailed breakdown of possible criteria). Foreach criterion, the LLM evaluator 545 assigns a score, for example ‘1’ if satisfied and ‘0’ if not. Criteria that are not applicable to a particular candidate query may receive a passing score if their omission does not affect output correctness.

### Example 6: Checklist Categories

Core Aspects (Criteria 1-7): These criteria focus on the fundamental aspects of the SQL query,
ensuring it accurately represents the natural language query's intent.

| | |
|---|---|
| ○ | Intent: Verifies if the SQL query aligns with the main objective of the natural language |
| | query (e.g., retrieval, counting, filtering, grouping, or ordering). |
| ○ | Required Columns: Checks if the SQL query selects the correct columns as specified in |
| | the natural language query. |
| ○ | Filters and Conditions: Ensures all filtering conditions are applied correctly on the |
| | correct columns with the correct values. |
| ○ | Logic: Validates the logic used in the SQL query, ensuring it aligns with the natural |
| | language query requirements. |
| ○ | Correct Tables and Joins: Confirms the correct tables are used and joined properly (if |
| | applicable). |
| ○ | Hallucinated or Assumed Knowledge: Identifies if the SQL query introduces assumptions |
| | or external knowledge not mentioned in the natural language query or database schema. |
| ○ | Oracle DB Executability: Verifies the SQL query is syntactically valid and executable on |
| | Oracle DB according to the provided database schema. |

Advanced Aspects (Criteria 8-12): These criteria delve deeper into advanced features of SQL
queries, ensuring proper implementation of complex operations.

| | |
|---|---|
| ○ | Aggregation Functions: Checks if the correct aggregation functions (e.g., SUM, AVG) are |
| | used where applicable. |
| ○ | Order By: Verifies the sorting (if required) is implemented correctly using ORDER BY. |
| ○ | Group By: Ensures grouping (if required) is implemented correctly using GROUP BY. |
| ○ | Subqueries: Evaluates the correctness and logical soundness of subqueries (if present). |
| ○ | Rank and Partition: Checks if rank and partitioning (e.g., ROW_NUMBER( ), RANK( ), |
| | PARTITION BY) are implemented correctly where necessary. |

Output Aspects (Criteria 13-14): These criteria focus on the output of the SQL query, ensuring it
meets the natural language query's requirements.

| | |
|---|---|
| ○ | Output Rows: Verifies the SQL query fetches the correct number of rows (e.g., using |
| | FETCH FIRST N ROWS ONLY or ROWNUM) as required by the natural language query. |
| ○ | Output Format: Ensures the output format (e.g., grouping, ordering) is consistent with the |
| | natural language query requirements. |

Optimization and Schema Validation (Criteria 15-16): These criteria assess the SQL query's
efficiency and adherence to the database schema.

| | |
|---|---|
| ○ | Schema Validation: Confirms all table and column names are correct based on the |
| | database schema. |
| ○ | Simplicity: Evaluates if the SQL query is free of unnecessary complexity while achieving |
| | the desired outcome. |

In addition to or instead of checklist-based evaluation, the LLM evaluator 545 may employ exact matching, which involves direct, character-level comparison of structured SQL elements (such as table and column names or values) between the candidate and a reference query, often after normalization (e.g., trimming whitespace, standardizing case, canonicalizing data types). Fuzzy matching may also be utilized, assessing semantic similarity or contextual equivalence between candidate and reference queries through embedding-based similarity metrics (such as cosine similarity or dot product), synonym recognition, paraphrase detection, and other advanced NLP techniques. Configurable thresholds may determine what level of similarity constitutes a “match,” and detailed explanations for similarity assessments may be included in evaluation reports.

The evaluation framework is highly adaptable, permitting user customization of criteria, aggregation logic, and prompt structure to suit specific tasks, schema characteristics, or operational objectives. The evaluation protocol may employ any combination of checklist, exact, and fuzzy matching, either alone or in concert, to ensure robust assessment of SQL correctness. Example 7 presents a representative structured prompt as may be supplied to the LLM evaluator 545 for checklist-based assessment, illustrating how explicit instructions, reference queries, and scoring rubrics are incorporated into the evaluation process.

### Example 7: Prompt Given to LLM Evaluator for Checklist-Based Assessment

Prompt:
You are an expert in SQL and natural language query translation. Your task is to evaluate whether
a given SQL query correctly implements the intent of a natural language query, using a strict
checklist-based scoring strategy.
# Instructions:

| | |
|---|---|
| 1. | Use the Database Schema, Natural Language Query (NL), SQL Query and the Oracle DB |
| | execution error (if available) provided below. Also, there is a correct example NL query |
| | and an SQL query for reference. |
| 2. | Evaluate the SQL query based on the criteria listed in the checklist. |
| 3. | For each criterion, assign a score of 1 (Pass) or 0 (Fail). If a criterion is not required or not |
| | applicable, then assign 1 to this score. |
| 4. | Provide a short explanation for each score, including specific matches or mismatches |
| | (use up to 10 words). |
| 5. | Compute the Final Score as the sum of all individual scores (maximum total is 16). |
| 6. | Based on the Final Score, determine the overall correctness: |

a. Correct (1) if all criteria pass.
b. Incorrect (0) if any criterion fails

#Evaluation Checklist
##Core Aspects:

| | |
|---|---|
| 1. | Intent: Does the SQL query align with the main intent of the NL query (e.g., retrieve, |
| | count, filter, group, order)? |
| 2. | Required Columns: Are the required columns correctly selected based on the NL query? |
| 3. | Filters and Conditions: Are all filtering conditions applied correctly on the correct |
| | columns with the correct values? |
| 4. | Logic: Is the logic used in the SQL correct and aligned with the NL query requirements? |
| 5. | Correct Tables and Joins: Are the correct tables used, and are they joined properly (if |
| | applicable)? |
| 6. | Hallucinated or Assumed Knowledge: Does the SQL query introduce assumptions or |
| | external knowledge not mentioned in the NL query or database schema (e.g., using |
| | country abbreviations, specific dates, or external context that was not specified)? |
| 7. | Oracle DB Executability: Is the SQL query syntactically valid and executable on Oracle |
| | DB according to the provided database schema? Ensure the query uses Oracle- |
| | compatible syntax (e.g., ‘ NVL’ instead of ‘ COALESCE’ , ‘ FETCH FIRST’ instead of |
| | ‘ LIMIT’). |

#### Advanced Aspects:

| | |
|---|---|
| 8. | Aggregation Functions: Are the correct aggregation functions used where applicable |
| | (e.g., ‘ SUM’, ‘ AVG’)? |
| 9. | Order By: Is the sorting (if required) implemented correctly using ‘ ORDER BY’ ? |
| 10. | Group By: Is the grouping (if required) implemented correctly using ‘ GROUP BY’ ? |
| 11. | Subqueries: Are all subqueries (if present) correct and logically sound? |
| 12. | Rank and Partition: Are rank and partitioning (e.g., ‘ ROW_NUMBER( )’, ‘ RANK( )’ , or |
| | ‘ PARTITION BY’ ) implemented correctly where necessary? |

#### Output Aspects:

| | |
|---|---|
| 13. | Output Rows: Does the SQL fetch the correct number of rows (e.g., using ‘ FETCH FIRST |
| | N ROWS ONLY’ or ‘ ROWNUM’ ) as required by the NL query? |
| 14. | Output Format: Is the output format (e.g., grouping, ordering) consistent with the NL |
| | query requirements? |

#### Optimization and Schema Validation:

| | |
|---|---|
| 15. | Schema Validation: Are all table and column names correct based on the database |
| | schema? |
| 16. | Simplicity: Is the SQL query free of unnecessary complexity while achieving the desired |
| | outcome? # Output Format: |

## Checklist Evaluation:

| | |
|---|---|
| - | Intent: [0 or 1] - Explanation |
| - | Required Columns: [0 or 1] - Explanation |
| - | Filters and Conditions: [0 or 1] - Explanation |
| - | Logic: [0 or 1] - Explanation |
| - | Correct Tables and Joins: [0 or 1] - Explanation |
| - | Hallucinated or Assumed Knowledge: [0 or 1] - Explanation |
| - | Oracle DB Executability: [0 or 1] - Explanation |
| - | Aggregation Functions: [0 or 1] - Explanation |
| - | Order By: [0 or 1] - Explanation |
| - | Group By: [0 or 1] - Explanation |
| - | Subqueries: [0 or 1] - Explanation |
| - | Rank and Partition: [0 or 1] - Explanation |
| - | Output Rows: [0 or 1] - Explanation |
| - | Output Format: [0 or 1] - Explanation |
| - | Schema Validation: [0 or 1] - Explanation |
| - | Simplicity: [0 or 1] - Explanation |

## Final Score: [Sum of Scores]
## Overall Correctness: [1 or 0]
## Final Explanation: A summary of the evaluation, including specific issues (if any) in a
hyphened list format.
---BEGIN!
Example NL and SQL for reference:
NL Query: {initial_query}
Gold SQL Query:
‘‘‘sql
{gold_sql}
’’’
Database Schema:
{db_schema}
Natural Language Query:
{user_query}
SQL Query:
‘‘‘sql
{sql_query}
’’’
Oracle DB Execution Error
{exec_error}
Provide the Checklist Evaluation, Final Score, Overall Correctness, and Final Explanation
Inputs:
DB schema, NL query, SQL query, DB engine execution errors
SQL: SELECT a.“AIRPORTNAME” FROM “ShS”.“AIRPORTS” a LEFT JOIN “ShS”.“FLIGHTS” f ON
a.“AIRPORTCODE” = f.“ SOURCEAIRPORT” WHERE f.“SOURCEAIRPORT” IS NULL
Outputs:
## Checklist Evaluation:

| | |
|---|---|
| - | Intent: 1 - Aligns with the main intent of the NL query |
| - | Required Columns: 1 - Correctly selects the required column “AIRPORTNAME” |
| - | Filters and Conditions: 1 - Applies the correct filtering condition on the correct column |
| | with the correct value |
| - | Logic: 1 - The logic used in the SQL is correct and aligned with the NL query requirements |
| - | Correct Tables and Joins: 1 - Uses the correct tables and joins them properly |
| - | Hallucinated or Assumed Knowledge: 1 - Does not introduce assumptions or external |
| | knowledge not mentioned in the NL query or database schema |
| - | Oracle DB Executability: 1 - The SQL query is syntactically valid and executable on Oracle |
| | DB |
| - | Aggregation Functions: 1 - No aggregation functions are required for this query |
| - | Order By: 1 - No ordering is required for this query |
| - | Group By: 1 - No grouping is required for this query |
| - | Subqueries: 1 - No subqueries are present in this query |
| - | Rank and Partition: 1 - No rank and partitioning are required for this query |
| - | Output Rows: 1 - Fetches the correct number of rows |
| - | Output Format: 1 - The output format is consistent with the NL query requirements |
| - | Schema Validation: 1 - All table and column names are correct based on the database |
| | schema |
| - | Simplicity: 1 - The SQL query is free of unnecessary complexity while achieving the |
| | desired outcome ## Final Score: 16 |

## Overall Correctness: 1
## Final Explanation: The SQL query correctly implements the intent of the natural language
query, selecting the names of all airports that have no flights departing from them.
The query uses the correct tables, joins, and filtering conditions, and does not introduce any
assumptions or external knowledge not mentioned in the NL query or database schema.
The query is syntactically valid and executable on Oracle DB, and the output format is consistent
with the NL query requirements.

After applying the selected evaluation methodologies, the LLM evaluator 545 aggregates the individual assessment results to generate a final evaluation outcome for each candidate SQL statement. In checklist-based evaluation, the total score is typically the sum of individual criterion scores (for example, a maximum of sixteen if sixteen criteria are used), and a statement is deemed correct if all required criteria are satisfied. For exact and fuzzy matching, aggregation may involve summing or averaging similarity scores, applying weights, majority voting, thresholding, or consensus algorithms. The aggregation process can be tailored to the specific needs of the pipeline, including statistical or ensemble modeling approaches to reconcile conflicting assessments or generate composite outcomes.

The LLM evaluator 545 generates an evaluation report for each candidate SQL statement. This report may include a composite score, detailed breakdowns for each criterion or similarity metric, and user-friendly explanations articulating the rationale for the determination of correctness or failure. Where applicable, the report provides structured hints or guidance for query correction, and may include transparency notes for fuzzy or exact match assessments. These evaluation reports are retained and supplied as structured feedback for an iterative refinement loop, enabling systematic correction and improvement of candidate SQL statements that initially fail validation.

Following completion of the dual validation process, any candidate SQL statements that failed execution-based validation, LLM-based evaluation, or both, may be further processed through an iterative refinement loop. During the iterative refinement process, structured feedback from both the database engine 543 (e.g., the execution reports comprising execution errors, diagnostic messages) and the LLM evaluator 545 (e.g., the evaluation reports comprising checklist scores, semantic similarity results, category-specific deficiencies) are incorporated into prompts provided to a generative model (e.g., LLM) tasked with revising the failed SQL queries. The generative model analyzes the feedback to identify logical, syntactic, or schema-related deficiencies, and generates a revised SQL query or set of actionable correction instructions that address the identified issues. This process may involve: (i) resolving specific syntax or execution issues flagged by the database engine, (ii) addressing logical or structural problems identified in the evaluation report, (iii) incorporating user feedback or domain-specific correction strategies, (iv) any combination thereof. The revised SQL query is then resubmitted to the dual validation process (execution and LLM evaluation). If the query still fails validation, the cycle repeats, integrating new feedback from the latest attempt, until the query passes all validation criteria, a predefined number of iterations is reached, or user-defined acceptance thresholds are met. This loop simulates an interactive correction process, akin to real-world usage where users or automated agents iteratively refine queries in response to errors or feedback, thereby enhancing robustness, adaptability, and the practical usability of the NL2SQL pipeline.

By way of example, below are several representative prompt formats that may be used within the iterative refinement loop. These prompt types enable the iterative refinement mechanism to address not only technical SQL errors but also logical misalignments, ambiguous user intent, or incomplete query construction, supporting a wide range of use cases and user expertise levels.

### Example 8A Execution and Evaluation Feedback for Direct SQL Correction

A prompt providing schema, NL query, the failed SQL, execution error, checklist evaluation, and reference examples, instructing the LLM to generate a corrected Oracle SQL query and a detailed explanation of changes.

Prompt:
You are an expert in SQL and Oracle databases. Your task is to generate a corrected Oracle SQL
query based on the provided inputs. Use the database schema, natural language query (NL), the
original SQL query, Oracle DB execution error (if provided), and the checklist evaluation report.
Also, a reference NL with its gold SQL is provided for your reference.
## Inputs:

| | |
|---|---|
| 1. | Database Schema: A list of tables, their columns, and data types in the Oracle database. |
| 2. | Natural Language Query (NL): The user-provided query in natural language. |
| 3. | SQL Query: The original SQL query submitted by the user. |
| 4. | Oracle DB Execution Error: The error message returned when executing the query in the |
| | Oracle DB (if available). |
| 5. | Checklist Evaluation Report: A detailed evaluation of the original SQL query against a |
| | checklist of correctness criteria. |

## Instructions:

| | |
|---|---|
| 1. | Analyze the provided Oracle DB Execution Error to identify specific syntax or execution |
| | issues. |
| 2. | Use the Checklist Evaluation Report to address logical and structural problems in the |
| | query. |
| 3. | Ensure that the corrected SQL query: |

a. Matches the intent of the Natural Language Query.
b. Adheres to the Database Schema.
c. Resolves all issues identified in the Oracle DB Execution Error.
d. Passes all criteria from the Checklist Evaluation Report, including:
e. Intent
f. Required Columns
g. Filters and Conditions
h. Logic
i. Correct Tables and Joins
j. Hallucinated or Assumed Knowledge
k. Oracle DB Executability
l. Aggregation Functions, Grouping, Ordering, Subqueries, etc.

| | |
|---|---|
| 4. | Validate the SQL query for Oracle DB compatibility, including syntax and features like |
| | ‘ FETCH FIRST’ , ‘ ROWNUM’, ‘ NVL’, etc. |
| 5. | Provide a detailed explanation of the corrections made. |

## Output:

| | |
|---|---|
| - | Corrected Oracle SQL Query: The revised Oracle SQL query. Ensure the query is valid for |
| | Oracle Database. Only produce SQL. |
| - | Explanation of Changes: A clear summary of the issues resolved, referencing specific |
| | inputs (e.g., Oracle error, checklist issues). |

BEGIN!
Example NL and SQL for reference:
NL Query: {initial_query}
Gold SQL Query:
‘‘‘sql
{gold_sql}
’’’
Database Schema:
{db_schema}
NL Query:
{user_query}
Incorrect SQL Query:
‘‘sql
{sql_query}
’’’
Oracle DB Execution Error:
{exec_error}
Checklist Report:
{checklist_report}
Inputs:
Assume the SQL generated from previous question is invalid.
SQL candidate: SELECT a.“AIRPORT” FROM “ShS”.“AIRPORTS” a LEFT JOIN “ShS”.“FLIGHTS” f ON
a.“ AIRPORTCODE” = f.“SOURCEAIRPORT” WHERE f.“SOURCEAIRPORT” IS NULL
Execution error: ORA-00904: “A”.“AIRPORT”: invalid identifier
DB Schema, NL query, SQL query, DB execution error, checklist evaluation report
Outputs:
SELECT a.“AIRPORTNAME” FROM “ShS”.“AIRPORTS” a LEFT JOIN “ShS”.“FLIGHTS” f ON
a.“AIRPORTCODE” = f.“ SOURCEAIRPORT” WHERE f.“SOURCEAIRPORT” IS NULL

### Example 8B: User-Friendly Correction Instructions

A prompt supplying schema, NL query, reference/correct SQL, incorrect SQL, and error messages, instructing the model to output concise, actionable natural language steps for revising the SQL.

Prompt:
You are an expert in SQL and natural language query translation. Your task is to provide clear,
concise, and accurate instructions to revise a given SQL query so that it correctly implements
the intent of a natural language query. Follow these guidelines to ensure your instructions are
effective and align with the original user query's requirements.
# Context:

| | |
|---|---|
| * | A database schema |
| * | A natural language query |
| * | A correct SQL query for reference |
| * | A wrong SQL query that needs revision |
| * | Optionally, an execution error message for additional context |

Only use the tables listed below:
{ }
User query: { }
Correct Oracle SQL: { }
Wrong Oracle SQL: { }
# Guidelines:

| | |
|---|---|
| 1. | Review the wrong SQL query and correct SQL query, comparing them against the |
| | database schema and the NL query. |
| 2. | Generate a list of concise, actionable correction instructions in natural language style to |
| | fix the wrong SQL query to the correct query. |

Output the correction instructions only to revise the wrong SQL query. Do not include the
corrected SQL query in the response. Use a natural language, user-friendly style for the
instructions.
Inputs:
User query: “List the names of all airports that have no flights departing from them.”
Correct Oracle SQL:
SELECT a.“AIRPORTNAME”
FROM “ShS”.“AIRPORTS” a
LEFT JOIN “ShS”.“FLIGHTS” f
ON a.“AIRPORTCODE” = f.“SOURCEAIRPORT”
WHERE f.“SOURCEAIRPORT” IS NULL;
Wrong Oracle SQL:
SELECT a.“AIRPORTNAME”
FROM “ShS”.“AIRPORTS” a
WHERE a.“AIRPORTCODE” NOT IN (SELECT f.“SOURCEAIRPORT” FROM “ShS”.“FLIGHTS” f);
Outputs:
Generated error feedback:
The NOT IN condition fails when SOURCEAIRPORT contains NULL values, potentially leading to
incorrect results.

| | |
|---|---|
| 1. | Use LEFT JOIN to include all airports, even those without departures. |
| 2. | Match airports with flights using SOURCEAIRPORT. |
| 3. | Filter airports where SOURCEAIRPORT is NULL, ensuring only those with no departing |
| | flights are selected. |

### Example 8C: Evaluation-Driven Granular Feedback

A prompt using evaluation results with category-based error Labeling, guiding the model to provide category-specific, actionable corrections, consolidated for clarity and completeness.

You are an expert in natural language and SQL query translation.
Your task is to provide clear, concise, and actionable instructions to revise a given SQL query so
that it accurately implements the intent of a provided user query in the following context.
# Context:
- Database Schema: A description of the database structure, including table names, columns,
and relationships.
{ }
- User Query: The natural language query describing the user's intent.
{ }
- Correct Oracle SQL Query: A reference query that correctly implements the user's intent.
{ }
- Wrong Oracle SQL Query: A query that contains errors and needs to be corrected.
{ }
- Evaluation Results: Details of discrepancies, with incorrect terms labeled with a value of 0.
{ }
# Guidelines:
Follow these guidelines step by step to ensure your instructions are effective, align with the
user's query, and adhere to the database schema.

| 1. | Understand the Context: | |
|---|---|---|
| | a. | Review the database schema to understand the structure and relationships. |
| | b. | Interpret the natural language query to ensure a clear understanding of the user's |
| | | intent. |
| 2. | Analyze Discrepancies: | |
| | a. | Compare the wrong SQL query and correct SQL query against the natural |
| | | language query and database schema. |
| | b. | Use the evaluation results to identify incorrect terms or components in the wrong |
| | | query, focusing on those labeled with a value of 0. |
| 3. | Consolidate Issues: | |
| | a. | Summarize all discrepancies found, grouping similar issues (e.g., incorrect |
| | | column references, missing conditions) into categories for clarity. |
| | b. | If the evaluation results are ambiguous or incomplete, rely on the database |
| | | schema and natural language query to infer corrections. |

| | |
|---|---|
| 4. | Generate Correction Instructions: |
| 5. | Provide concise, actionable instructions to correct each issue in the wrong SQL query. |
| 6. | Ensure the instructions are written in a natural, user-friendly style, suitable for a user |
| | with moderate SQL knowledge. |
| 7. | Focus on aligning the query with the natural language intent and database schema. |

# Output:
Only provide the correction instructions to revise the wrong SQL query. Do not include the
corrected SQL query in the response. Ensure the instructions are easy to follow and address all
identified issues.

### Example 8D: Dialog-Based Interactive Correction

A multi-turn prompt reflecting an exchange where the model receives user-guided instructions based on execution errors or evolving requirements and generates a revised SQL query in response.

Example:
User:
Given an input Question, create a syntactically correct Oracle SQL query to run.\nPay attention
to using only the column names that you can see in the schema description.\nBe careful to not
query for columns that do not exist. Also, pay attention to which column is in which
table.\nPlease double check that the SQL query you generate is valid for Oracle Database. \nDO
NOT use alias in the SELECT clauses.\nOnly use the tables listed below.\n
{db_schema}
Question: Which titles were directed by Ben Jones or Brandon Vietti?\nOracle SQL:
Assistant:
SELECT Title FROM Cartoon WHERE Directed_by = ‘Ben Jones' OR Directed_by = ‘Brandon Vietti’
User:
What are their original air dates?
Assistant:
SELECT Original_air_date...d_by = ‘Brandon Vietti’
User:
{correction_instructions}
Inputs:
Based on the execution error message: “Executed results do NOT match.”, user correction
instructions are generated as follows: “To correct the wrong SQL query, follow these steps:

| | |
|---|---|
| 1. | Add the missing ‘title’ column to the SELECT clause to ensure that both ‘title’ and |
| | ‘original_air_date’ are included in the output. |
| 2. | Modify the SELECT clause to include both columns, separated by a comma, to achieve a |
| | consistent output format. |

By addressing these issues, you will be able to revise the wrong SQL query to correctly
implement the intent of the natural language query and produce the expected output.”
Outputs:
SELECT Title, original_air_date FROM Cartoon WHERE Directed_by = ‘Ben Jones' OR Directed_by
= ‘Brandon Vietti’

At the conclusion of the multi-turn NL2SQL data augmentation pipeline 500, candidate SQL statements that do not pass the dual validation process may be removed so that only those statements producing valid, non-empty results are retained for further processing. Following this optional filtering step, the remaining validated candidate SQL statements, together with their corresponding natural language utterances, are used to generate a multi-turn natural language to query training dataset.

In some embodiments, the multi-turn natural language to query training dataset may be used to train and/or fine-tune NL2SQL models (e.g., M2 Base/Premium model) to improve their error resilience and generalization capabilities in multi-turn conversational scenarios. During training, the model may be exposed to a range of natural language queries paired with validated, corrected SQL statements, as well as corresponding feedback reflecting both successful and unsuccessful query executions. The training objective may involve minimizing a sequence-level loss function, such as cross-entropy loss, between the model's predicted SQL outputs and the reference SQL queries found in the dataset. By learning from examples that span diverse linguistic expressions, schema variations, and iterative correction cycles, the model acquires the ability to produce accurate initial SQL queries and to effectively incorporate feedback for subsequent refinements. Through this approach, the NL2SQL model is systematically conditioned to interpret multi-turn user interactions, address common sources of error, and adapt to evolving database structures and user requirements.

Once the generative model has been fine-tuned or trained, it may be deployed into a production environment to perform inference tasks on real-world multi-turn natural language inputs. In various embodiments, the production environment may be part of an automated text-to-SQL agent system (e.g., SQL agent system 200 described with respect to FIG. 2) operating within a cloud-based infrastructure (e.g., IaaS cloud-based environment described and illustrated in FIGS. 7-11) or enterprise analytics platform. The deployed model may receive user queries in natural language, generate corresponding SQL statements, and leverage iterative refinement mechanisms to address execution errors or user feedback in real-time. Operational metrics such as query accuracy, response latency, and user satisfaction may be monitored to ensure ongoing model performance and reliability. Additionally, the model may require retraining or updates based on new data or changing conditions in the environment to prevent model drift.

### EXAMPLES

The following examples are provided by way of illustration only and not by way of limitation. Those of skill in the art will readily recognize a variety of non-critical parameters that could be changed or modified to yield essentially the same or similar results.

### Multi-Turn Data Tagging and Data Construction

To evaluate and fine-tune a multi-turn NL2SQL model, multi-turn tagged data were derived from the publicly available CoSQL and SparC datasets. To create the multi-turn data, multi-turn conversations were extracted from the CoSQL and SparC datasets. Each conversation was tagged according to its functional role in the dialog: as an independent question, a referential question, a modifying question, a filtering question, a referential-results question, or as invalid.

Additional follow-up queries of targeted dependency types were generated using the described data augmentation pipeline (pipeline 500 described with respect to FIG. 5), and appended to extend the conversation coverage. The extended conversations were then split into training and validation sets (see Tables 3 and 4).

TABLE 3
Augmented Data Sets: Training Data Statistics

| Tag | CoSQL | SparC |
|---|---|---|
| Independent | 852 | 715 |
| Referential-Question | 581 | 331 |
| Modifying | 234 | 273 |
| Filtering | 151 | 325 |
| Referential-Results | 16 | 0 |
| Invalid Questions | 8 | 0 |
| Total Tags | 1,842 | 1,644 |

TABLE 4
Augmented Data Sets: Testing Data Statistics

| Tag | CoSQL | SparC |
|---|---|---|
| Independent | 622 | 472 |
| Referential-Question | 128 | 222 |
| Modifying | 100 | 160 |
| Filtering | 95 | 124 |
| Referential-Results | 82 | 85 |
| Invalid Questions | 4 | 0 |
| Total Tags | 1,033 | 1,063 |

Additionally, error correction datasets were produced by simulating user feedback and query refinement steps across Oracle SQL and SQLite dialects for both training and testing datasets. See Tables 5 and 6 below.

TABLE 5
Error Correction Data: Training Data Statistics

| Dataset | Oracle SQL | SQLite |
|---|---|---|
| CoSQL | 637 | 658 |
| SparC | 466 | 830 |

TABLE 6
Error Correction Data: Testing Data Statics

| Dataset | Oracle SQL | SQLite |
|---|---|---|
| CoSQL | 109 | 118 |
| SparC | 118 | 234 |

### Fine-Tuning on Extended CoSQL and SparC Multi-Turn Date

To evaluate the effectiveness of the multi-turn NL2SQL data augmentation pipeline in generating multi-turn training data, the single-turn M2 Base model was trained and tested on the expanded multi-turn datasets derived from CoSQL and SparC. During training, a batch balancing strategy was implemented, applying a 2:1 ratio of new multi-turn training data to original M2 Base training data to mitigate catastrophic forgetting. The M2 model's performance was subsequently evaluated on both the multi-turn testing dataset and single-turn Spider test sets. As shown in Table 7 below, the fine-tuned M2 model exhibited substantial improvements on the multi-turn testing dataset, with average scores increasing from 71.7 to 80.4, while maintaining comparable results on the single-turn Spider test sets (76.2 compared to 76.9).

TABLE 7

| | | | | | | SQLite | SQLite | AVG of |
|---|---|---|---|---|---|---|---|---|
| | Oracle SQL | | SQLite | | AVG of Multi- | Spider | Spider | Spider |
| Model | CoSQL | SparC | CoSQL | SparC | turn Tests | Dev | Realistic | Tests |
| M2 Base (baseline) | 72.6 | 71.9 | 71.8 | 70.4 | 71.7 | 77.9 | 74.4 | 76.2 |
| Fine-tuned model | 80.9 | 79.0 | 79.2 | 82.3 | 80.4 | 78.8 | 75.0 | 76.9 |
| (checkpoint 400) | | | | | | | | |

### Fine-Tuning on Extended CoSQL and SparC and Error Correct Multi-Turn Data

To evaluate the effectiveness of the multi-turn NL2SQL data augmentation pipeline in generating multi-turn training data, the single-turn M2 Base model was trained and tested on the expanded multi-turn datasets and the multi-turn error correction datasets derived from CoSQL and SparC, as well as the single-turn Spider datasets. During training, a batch balancing strategy was implemented, applying a 1:1:1 ratio of M2 Base training data, the expanded multi-turn training dataset, and the multi-turn error correction training dataset. The M2 model's performance was subsequently evaluated on the expanded multi-turn testing dataset, the multi-turn error correction testing dataset, and the single-turn Spider test set. As shown in Tables 8A-8C below, the fine-tuned M2 model achieved substantial improvements on the multi-turn development set, with average scores increasing from 71.7 to 80.6. Modest improvements were observed on the multi-turn error correction development sets, with scores rising from 70.4 to 71.8. On the single-turn Spider test sets, performance showed a slight improvement from 74.3 to 75.3.

TABLE 8A
Spider Development Dataset

| | Spider Development Dataset | | | | |
|---|---|---|---|---|---|
| | AVG of | | | | |
| | Spider | SQLite | | Oracle SQL | |
| | Dev | Spider | Spider | Spider | Spider |
| Model | Sets | Dev | Realistic | Dev | Realistic |
| M2 Base (baseline) | 74.3 | 78.5 | 76 | 74.5 | 68 |
| Fine-tuned model | 75.3 | 79 | 74.6 | 75.7 | 71.7 |
| (checkpoint 300) | | | | | |

TABLE 8B
Multi-turn Error Correction Dataset

| | Multi-turn Error Correction Dataset | | | | | | | | |
|---|---|---|---|---|---|---|---|---|---|
| | | | | | | SQLite- | | Oracle SQL- | |
| | | SQLite-Spider Test | | Oracle SQL-Spider Test | | Execution | | Execution | |
| | AVG of | Execution | Semantic | Execution | Semantic | and Semantic | | and Semantic | |
| | Multi-turn | Error | Error | Error | Error | Correction | | Correction | |
| Model | Error | Correction | Correction | Correction | Correction | CoSQL | SparC | CoSQL | SparC |
| M2 Base (baseline) | 70.4 | 44.1 | 83 | 46.5 | 78 | 81.6 | 84.2 | 72.3 | 73.3 |
| Fine-tuned model | 71.8 | 53.8 | 84 | 61.6 | 83 | 71.4 | 78.1 | 69.4 | 73.3 |
| (checkpoint 300) | | | | | | | | | |

TABLE 8C
Multi-turn CoSQL and SparC Datasets

| | Multi-turn CoSQL and SparC Datasets | | | | |
|---|---|---|---|---|---|
| | AVG of | SQLite | | Oracle SQL | |
| Model | Multi-turn | CoSQL | SparC | CoSQL | SparC |
| M2 Base (baseline) | 71.7 | 71.8 | 70.4 | 72.6 | 71.9 |
| Fine-tuned model | 80.6 | 80.1 | 79.9 | 81.7 | 80.8 |
| (checkpoint 300) | | | | | |

### Illustrative Method

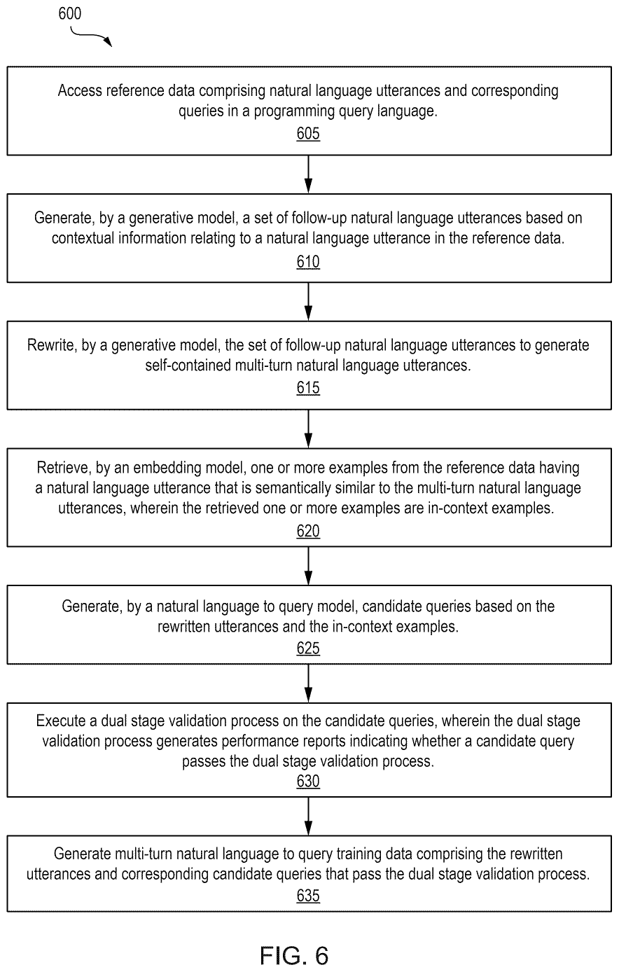

FIG. 6 is a flowchart illustrating a process 600 for generating context-aware, multi-turn natural Language to SQL training data for database query models, according to various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1-5, the processing depicted in FIG. 6 may be performed by an agent system (e.g., SQL agent system 200 described with respect to FIG. 2).

It is to be understood that the generative models, artificial intelligence models, and related components described herein, such as those employed in the natural language query generation process, the contextual rewriting process, the in-context learning retrieval process, the SQL query generation process, and the validation processes, may be implemented using the same model, different models, or any subset thereof may be the same or different, depending on the requirements of a particular embodiment. For example, in some embodiments, a single AI model or generative model may be configured to perform multiple tasks across the pipeline, while in other embodiments, separate models specialized for follow-up query generation, contextual rewriting, SQL synthesis, or validation may be used. Moreover, any combination or sub-combination of these models or modules may be employed, and the allocation of tasks among models may be varied without departing from the scope of the present disclosure. The architecture is thus modular and extensible, supporting replacement, augmentation, or reconfiguration of models and components as technical advances or application needs dictate.

At box 605, reference data comprising natural language utterances and corresponding queries in a programming query language are accessed. In general, the reference data may encompass any dataset or collection of data points that associates natural language expressions with structured queries, regardless of format, source, or method of generation. This reference data may be selected, curated, or synthesized to suit the requirements of a particular implementation, use case, or target domain.

For example, in some embodiments, the reference data may include benchmark single-turn NL2SQL pairs derived from widely recognized academic or industry datasets. In other embodiments, the reference data may further comprise synthetic examples generated through automated data augmentation pipelines, such as paraphrasing, schema randomization, or controlled template expansion. The reference data may alternatively or additionally include historical user interactions, logs of prior dialog sessions, or queries captured from deployed natural language database interfaces. Sources of reference data may encompass publicly available corpora, proprietary datasets, crowd-sourced or expert-annotated collections, as well as data generated in situ by the system during active deployment.

In other embodiments, the reference data may be domain-specific (e.g., tailored for healthcare, finance, or e-commerce), or may span multiple domains to support generalization. The data may be acquired in real time, batch-processed, or periodically updated to reflect evolving user needs or schema changes. Furthermore, the reference data may include examples that vary in complexity, such as single-turn queries, multi-turn dialog fragments, synthetically constructed edge cases, or adversarial examples designed to test system robustness.

At box 610, a set of follow-up natural language utterances based on contextual information relating to a natural language utterance in the reference data are generated by one of the one or more generative models. The set of follow-up natural language utterances are generated by providing, as part of a prompt to one of the one or more generative models, a follow-up trajectory that specifies logical dependency types for the follow-up utterances and a target database schema. In various embodiments, the follow-up trajectory comprises a pre-compiled set of logically consistent follow-up questions (for example, those shown in Table 2), which may be randomly selected during generation to promote diversity and generalization. Alternatively, the follow-up trajectory may be explicitly specified, either by the system, a user, or an external process, to enforce a particular sequence or pattern of follow-up questions, such as when simulating targeted interaction flows or testing specific dialog scenarios. In further embodiments, the follow-up trajectory may be dynamically adapted in real time based on user input, dialog history, or system-defined objectives, thereby enabling the generation of multi-turn dialogs that are responsive to evolving context or testing requirements. In various embodiments, the follow-up natural language utterances comprise referential-based utterances, referential-result based utterances, filtering utterances, modifying utterances, utterances simulating database execution errors, utterances simulating user feedback, or any combination thereof.

In various embodiments, the generative model that generates the set of follow up natural language utterances is an LLM configured to leverage the target database schema and the natural language utterance in the reference data to generate follow-up natural language utterances that simulate how a user might naturally continue a conversation with a database system. Alternatively, the generative model may be a smaller-scale language model, a domain-adapted or fine-tuned transformer, a sequence-to-sequence neural network, a retrieval-augmented generation model, or any suitable AI-based or hybrid system capable of producing coherent, contextually relevant follow-up utterances. In some embodiments, the model may also be conditioned on additional features, such as user profile information, dialog history, prior execution results, or system-defined dialog goals.

At box 615, the set of follow-up natural language utterances are rewritten, by one of the one or more generative models to generate self-contained multi-turn natural language utterances. In various embodiments, rewriting comprises integrating contextual elements from the natural language utterance in the reference data, previous follow-up utterances in the set of follow-up natural language utterances, or both. In alternative embodiments, the rewriting may further comprise: (i) resolving pronouns, deictic expressions, or other referential language to their explicit antecedents, (ii) concatenating or paraphrasing relevant information from the dialog history to ensure completeness and unambiguity, (iii) applying rule-based or template-driven expansion to fill in omitted details or clarify logical dependencies, (iv) leveraging external knowledge sources, such as schema documentation or metadata, to supplement missing context, (v) using a pipeline of models, wherein a first model identifies missing or ambiguous elements and a second model incorporates the necessary clarifications, (vi) incorporating feedback or corrections from prior validation steps, such as user suggestions or error diagnostics, to further refine the rewritten utterance, or (vii) any combination thereof.

In various embodiments, the contextual elements comprise entities, filtering conditions, parameters, or results that would otherwise be implicitly derived from earlier exchanges within the natural language utterance in the reference data, previous follow-up utterances in the set of follow-up natural language utterances, or both. Accordingly, a self-contained multi-turn natural language utterance comprises all contextual information necessary for its independent interpretation and processing, such that the intended meaning and operative details of the rewritten utterance are ascertainable solely from the text of the rewritten utterance itself, without requiring reference to any previous conversational turns, prior queries, or external conversational state.

At box 620, one or more examples from the reference data having a natural language utterance that is semantically similar to the multi-turn natural language utterances are retrieved by one of one or more AI models, wherein the retrieved one or more examples are in-context examples. In various embodiments, the AI model responsible for retrieving the one or more examples is an embedding model configured to vectorize the one or more examples from the reference data and the multi-turn natural language utterances and determine a semantic similarity score between them.

At box 625, candidate queries based on the multi-turn natural language utterances and the in-context examples are generated by one of the one or more AI models. In various embodiments, a natural language to query model (e.g., a NL2SQL) model is used to generate the candidate queries.

At box 630, a dual stage validation process is executed on the candidate queries, wherein the dual stage validation process generates performance reports indicating whether a candidate query passes the dual stage validation process. In various embodiments, the dual stage validation process comprises a first stage in which the candidate queries are executed against a database schema, and execution reports indicating whether each candidate query executed correctly are received. In various embodiments, a database engine performs the execution. The execution reports may include error messages, diagnostic information, and other relevant feedback concerning the candidate query's interaction with the database engine. Additionally, execution reports can be augmented to include user-friendly natural language explanations and structured hints derived from the identified errors, thereby enabling users to refine their queries accordingly.

In a second stage of the dual stage validation process, the candidate queries are evaluated by one of the one or more AI models according to evaluation criteria, and evaluation reports indicating whether each candidate query passed the evaluation criteria are received. In various embodiments, a judge LLM evaluates the candidate queries using a checklist-based evaluation method. The checklist-based evaluation method comprises multiple evaluation criteria, which may include: (i) core aspects, such as alignment with the intent of the natural language query, use of required columns, application of filters and conditions, logical fidelity, correct use of tables and joins, avoidance of hallucinated or extraneous knowledge, and syntactic validity with respect to the target database; (ii) advanced aspects, such as correct use of aggregation functions, implementation of ordering and grouping clauses, logical construction of subqueries, and proper application of ranking or partitioning features; (iii) output aspects, such as retrieval of the appropriate number of rows and conformity of the output format to the user's requirements; and (iv) optimization and schema validation, including the accuracy of table and column references and the avoidance of unnecessary query complexity. In various embodiments, the judge LLM assigns an individual score to each evaluation criterion, reflecting the degree to which the candidate query satisfies the specified requirement. The individual scores are then summed to determine a total score for the candidate query, and the query is deemed to have passed the second stage if the total score satisfies a predetermined threshold.

After completion of the first and second stages of the dual stage validation process, the results in the execution reports and the evaluation reports are aggregated to determine whether a candidate query passes the dual validation, wherein the performance reports comprise the execution reports and the evaluation reports. When candidate queries fail the first stage of the dual stage validation process, the second stage of the dual stage validation process, or both, the failed candidate queries are further processed by an iterative refinement loop. In various embodiments, the iterative refinement loop is executed by one of the one or more AI models, wherein the performance reports for the failed candidate queries and simulated user feedback utterances are incorporated into a prompt of the AI model and the iterative refinement loop repeats the method described in box 630 for one or a predetermined number of iterations, or until a candidate query passes the first stage and the second stage of the dual stage validation process. Optionally, if a candidate query fails to pass the dual stage validation process after a predetermined number of iterations, the failed candidate query may be removed.

In various embodiments, the methods described in relation to boxes 610 and 615 are performed by one or more generative models as a natural language utterance generation process configured to generate multi-turn natural language utterances, including, for example, the generation and rewriting of follow-up utterances. In parallel or in sequence, the methods described with respect to boxes 620 and 630 are performed by one or more artificial intelligence (AI) models as a query generation process configured to generate candidate queries corresponding to the multi-turn natural language utterances. This dual-process pipeline structure may be implemented as distinct, cooperating subsystems, or as integrated stages within a unified system. In some embodiments, these processes may be performed in any suitable order, combination, or level of integration by one or more models or modules, depending on system architecture, deployment requirements, or application context.

At box 635, multi-turn natural language to query training data comprising the multi-turn natural language utterances (e.g., the rewritten utterances from box 615) and corresponding candidate queries that pass the dual stage validation process are generated. In various embodiments, the multi-turn natural language to query training data is used to train and/or fine-tune a generative model on multi-turn conversation tasks. The training process may involve minimizing a token-level loss function, such as cross-entropy loss, by comparing the model's outputs to target structured queries given input prompts that may include schema and contextual information. Alternative training objectives can also be employed, including sequence-level loss, reinforcement learning rewards, curriculum learning techniques, or adversarial objectives to further enhance model performance and generalization. Additionally, the training process may incorporate regularization strategies, data augmentation methods, or curriculum scheduling to address challenges such as class imbalance, overfitting, or domain shift.

In various embodiments, a held-out validation split may be used to monitor performance during training, optimize hyperparameters, or implement early stopping strategies. Model evaluation can be conducted using metrics such as execution accuracy, semantic match, or other domain-specific measures, and may also include assessment of robustness to ambiguous or adversarial queries. Once the model has been trained or fine-tuned, it may be deployed in a variety of environments, including live conversational interfaces, batch query generation workflows, or as a component within broader data analytics pipelines.

The multi-turn natural language to query training data can also be used to adapt a single-turn NL2SQL model for handling multi-turn or contextually dependent queries, by leveraging the self-contained, rewritten utterances found in each training pair. The system may further support continual learning or incremental updates, enabling deployed models to benefit from newly collected dialog and query pairs as the system operates overtime.

Once the generative model has been fine-tuned or trained, it may be deployed into a production environment to perform inference tasks on real-world input data. In various embodiments, the production environment may be part of an automated text-to-SQL agent system (e.g., SQL agent system 200 described with respect to FIG. 2) operating within a cloud-based infrastructure (e.g., IaaS cloud-based environment described and illustrated in FIGS. 7-11) or enterprise analytics platform. In various embodiments, the deployed model's inference accuracy, response times, and other operational metrics may be monitored to ensure the model continues to perform as expected overtime. As the database is revised and/or as the needs of the user population evolve, the generative model may require retraining or updates to maintain optimal performance based on new data or changing conditions present in the production environment. In some embodiments, retraining may comprise updating the model's parameters using newly collected multi-turn natural language to query training data, incorporating additional or modified reference data reflecting changes in the database schema, user behavior, or domain requirements, or re-executing the pipeline steps (e.g., in-context example retrieval, prompt construction, and dual stage validation) on an updated dataset. Retraining may further involve fine-tuning the generative model with augmented or domain-adapted data, recalibrating model hyperparameters, introducing new or revised evaluation criteria, or integrating refreshed in-context examples harvested from recent production logs or user interactions. This ongoing process enables the system to adapt to evolving environments, ensuring that the deployed model remains accurate, robust, and responsive to current operational needs.

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

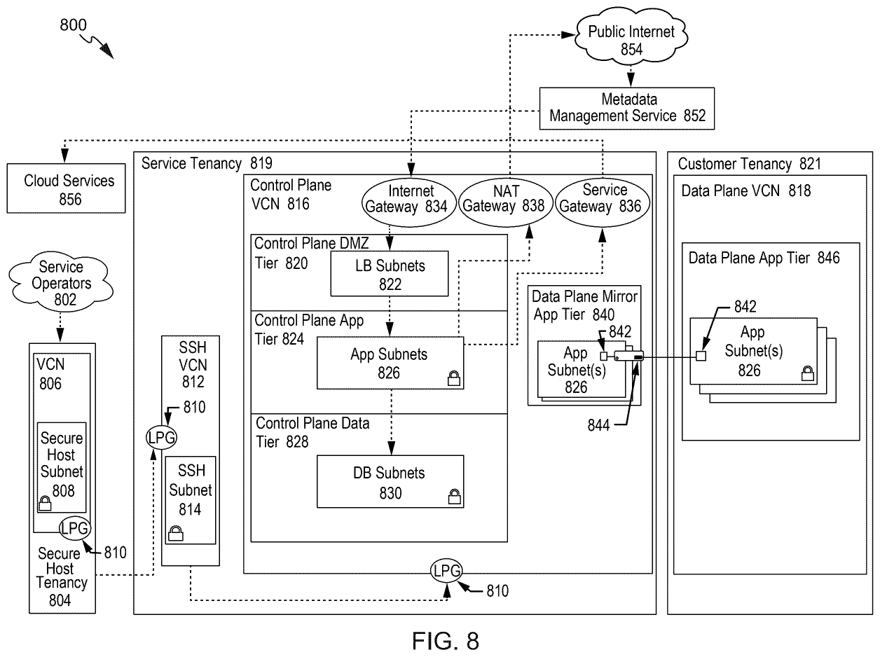

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

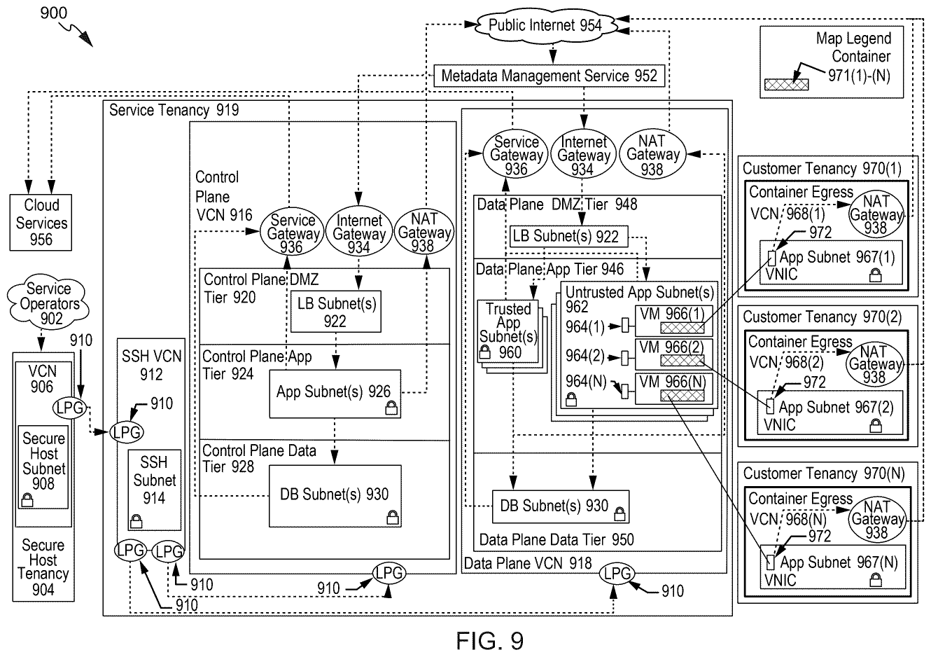

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

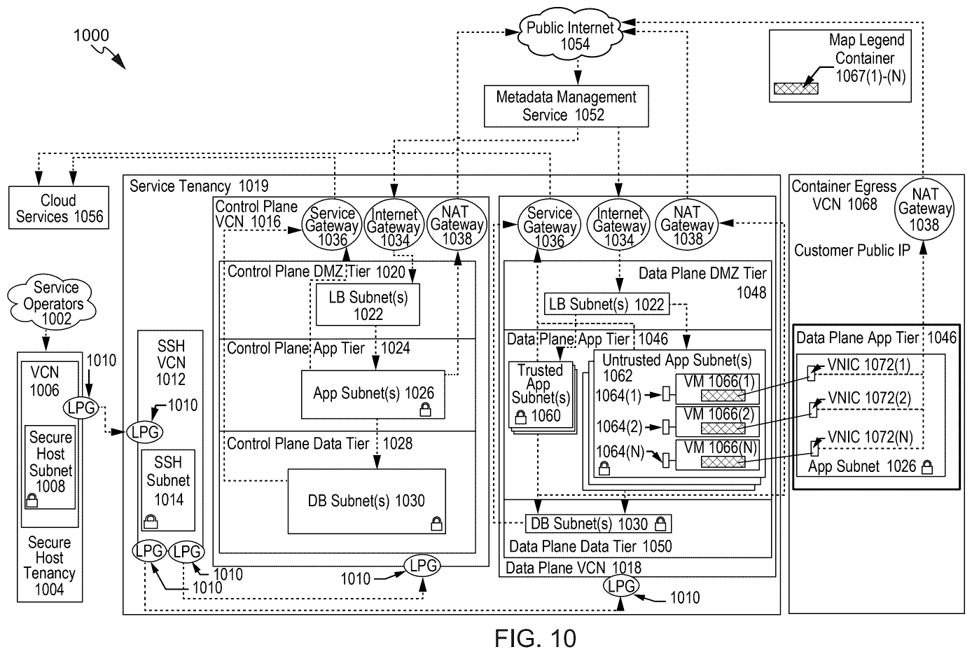

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

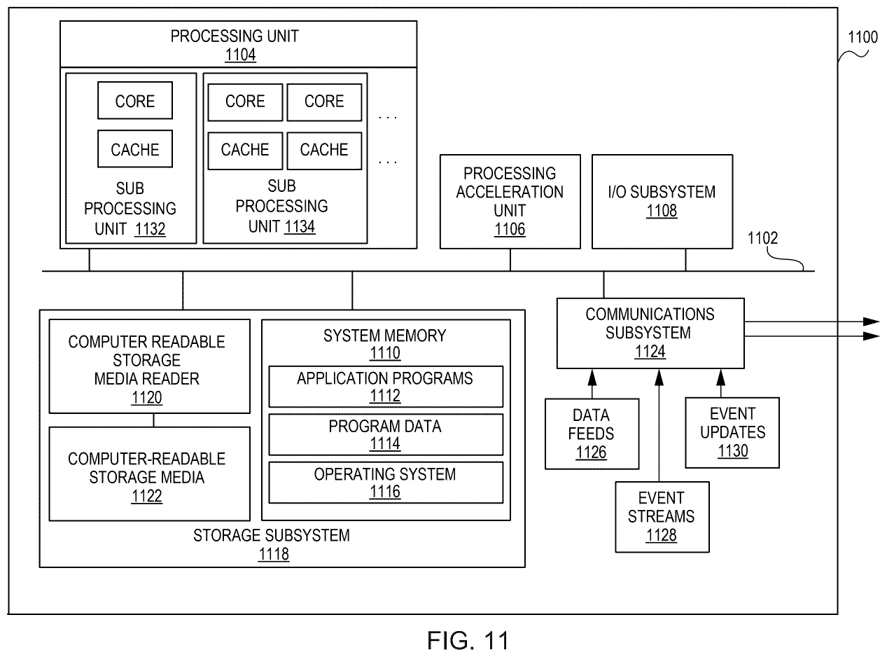

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an 1/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palme OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Btu-Ray disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing reference data comprising natural language utterances and corresponding queries in a programming query language;
executing, by one or more generative models, a natural language utterance generation process to generate multi-turn natural language utterances, wherein executing comprises:
generating, by one of the one or more generative models, a set of follow-up natural language utterances based on contextual information relating to a natural language utterance in the reference data, and
rewriting, by one of the one or more generative models, the set of follow-up natural language utterances to generate self-contained multi-turn natural language utterances;
executing, by one or more artificial intelligence (AI) models, a query generation process to generate candidate queries corresponding to the multi-turn natural language utterances, wherein executing comprises:
retrieving, by one of the one or more AI models, one or more examples from the reference data having a natural language utterance that is semantically similar to the multi-turn natural language utterances, wherein the retrieved one or more examples are in-context examples,
generating, by one of the one or more AI models, candidate queries based on the multi-turn natural language utterances and the in-context examples, and
executing, using one of the one or more AI models, a dual stage validation process on the candidate queries, wherein the dual stage validation process generates performance reports indicating whether a candidate query passes the dual stage validation process; and
generating multi-turn natural language to query training data comprising the multi-turn natural language utterances and corresponding candidate queries that pass the dual stage validation process.

2. The computer-implemented method of claim 1, wherein generating the set of follow-up natural language utterances comprises providing, as part of a prompt to one of the one or more generative models, a follow-up trajectory that specifies logical dependency types for the follow-up natural language utterances and a target database schema.

3. The computer-implemented method of claim 1, wherein the follow-up natural language utterances comprise referential-based utterances, referential-result based utterances, filtering utterances, modifying utterances, utterances simulating database execution errors, utterances simulating user feedback, or any combination thereof.

4. The computer-implemented method of claim 1, wherein the rewriting comprises integrating contextual elements from the natural language utterance in the reference data, previous follow-up utterances in the set of follow-up natural language utterances, or both.

5. The computer-implemented method of claim 1, wherein the dual stage validation process comprises:
executing the candidate queries against a database schema;
receiving execution reports indicating whether each candidate query executed correctly;
evaluating, by one of the one or more AI models, the candidate queries according to evaluation criteria;
receiving evaluation reports indicating whether each candidate query passed the evaluation criteria; and
aggregating the results in the execution reports and the evaluation reports to determine whether a candidate query passes the dual validation, wherein the performance reports comprise the execution reports and the evaluation reports.

6. The computer-implemented method of claim 1, wherein the dual stage validation process further comprises:
when candidate queries fail a first stage of the dual stage validation process, a second stage of the dual stage validation process, or both:
executing, by one of the one or more AI models, an iterative refinement loop, wherein the performance reports for the failed candidate queries and simulated user feedback utterances are incorporated into a prompt of the AI model and the iterative refinement loop repeats the dual stage validation process for one or a predetermined number of iterations, or until a candidate query passes the first stage and the second stage of the dual stage validation process.

7. The computer-implemented method of claim 1 further comprising training a generative model using the multi-turn natural language to query training data.

8. A system comprising:
one or more processors; and
one or more computer-readable media storing instructions which, when executed by the one or more processors, cause the system to perform operations comprising:
(i) accessing reference data comprising natural language utterances and corresponding queries in a programming query language;
(ii) generating, by a generative model, a set of follow-up natural language utterances based on contextual information relating to a natural language utterance in the reference data;
(iii) rewriting, by a generative model, the set of follow-up natural language utterances to generate self-contained multi-turn natural language utterances;
(iv) retrieving, by an embedding model, one or more examples from the reference data having a natural language utterance that is semantically similar to the multi-turn natural language utterances, wherein the retrieved one or more examples are in-context examples;
(v) generating, by a natural language to query model, candidate queries based on the multi-turn natural language utterances and the in-context examples;
(vi) executing, by one or more AI models, a dual stage validation process on the candidate queries, wherein the dual stage validation process generates performance reports indicating whether a candidate query passes the dual stage validation process; and
(vii) generating multi-turn natural language to query training data comprising the multi-turn natural language utterances and corresponding candidate queries that pass the dual stage validation process.

9. The system of claim 8, wherein generating the set of follow-up natural language utterances comprises providing, as part of a prompt to one of the one or more generative models, a follow-up trajectory that specifies logical dependency types for the follow-up natural language utterances and a target database schema.

10. The system of claim 8, wherein the follow-up natural language utterances comprise referential-based utterances, referential-result based utterances, filtering utterances, modifying utterances, utterances simulating database execution errors, utterances simulating user feedback, or any combination thereof.

11. The system of claim 8, wherein the rewriting comprises integrating contextual elements from the natural language utterance in the reference data, previous follow-up utterances in the set of follow-up natural language utterances, or both.

12. The system of claim 8, wherein the dual stage validation process comprises:
executing the candidate queries against a database schema;
receiving an execution report indicating whether each candidate query executed correctly;
evaluating, by one of the one or more AI models, the candidate queries according to evaluation criteria;
receiving evaluation reports indicating whether each candidate query passed the evaluation criteria; and
aggregating the results in the execution reports and the evaluation reports to determine whether a candidate query passes the dual validation, wherein the performance reports comprise the execution reports and the evaluation reports.

13. The system of claim 8, wherein the dual stage validation process further comprises:
when candidate queries fail a first stage of the dual stage validation process, a second stage of the dual stage validation process, or both:
executing, by one of the one or more AI models, an iterative refinement loop, wherein the performance reports for the failed candidate queries and simulated user feedback utterances are incorporated into a prompt of the refinement generative model and the iterative refinement loop repeats step (vi) for one or a predetermined number of iterations, or until a candidate query passes the first stage and the second stage of the dual stage validation process.

14. The system of claim 8 further comprising training a generative model using the multi-turn natural language to query training data.

15. One or more non-transitory computer-readable media storing instructions which, when executed by one or more processors, cause the one or more processors to perform operations comprising:
(i) accessing reference data comprising natural language utterances and corresponding queries in a programming query language;
(ii) generating, by a generative model, a set of follow-up natural language utterances based on contextual information relating to a natural language utterance in the reference data;
(iii) rewriting, by a generative model, the set of follow-up natural language utterances to generate self-contained multi-turn natural language utterances;
(iv) retrieving, by an embedding model, one or more examples from the reference data having a natural language utterance that is semantically similar to the multi-turn natural language utterances, wherein the retrieved one or more examples are in-context examples;
(v) generating, by a natural language to query model, candidate queries based on the multi-turn natural language utterances and the in-context examples;
(vi) executing, by one or more AI models, a dual stage validation process on the candidate queries, wherein the dual stage validation process generates performance reports indicating whether a candidate query passes the dual stage validation process; and
(vii) when candidate queries fail a first stage of the dual stage validation process, a second stage of the dual stage validation process, or both:
executing, by a refinement generative model, an iterative refinement loop, wherein at least the performance reports for the failed candidate queries are incorporated into a prompt of the refinement generative model and the iterative refinement loop repeats step (vi) for one or a predetermined number of iterations, or until a candidate query passes the first stage and the second stage of the dual stage validation process; and
(viii) generating multi-turn natural language to query training data comprising the multi-turn natural language utterances and corresponding candidate queries that pass the dual stage validation process.

16. The one or more non-transitory computer-readable media of claim 15, wherein generating the set of follow-up natural language utterances comprises providing, as part of a prompt to one of the one or more generative models, a follow-up trajectory that specifies logical dependency types for the follow-up natural language utterances and a target database schema.

17. The one or more non-transitory computer-readable media of claim 15, wherein the follow-up natural language utterances comprise referential-based utterances, referential-result based utterances, filtering utterances, modifying utterances, utterances simulating database execution errors, utterances simulating user feedback, or any combination thereof.

18. The one or more non-transitory computer-readable media of claim 15, wherein the rewriting comprises integrating contextual elements from the natural language utterance in the reference data, previous follow-up utterances in the set of follow-up natural language utterances, or both.

19. The one or more non-transitory computer-readable media of claim 15, wherein the dual stage validation process comprises:
executing the candidate queries against a database schema;
receiving an execution report indicating whether each candidate query executed correctly;
evaluating, by one of the one or more AI models, the candidate queries according to evaluation criteria;
receiving evaluation reports indicating whether each candidate query passed the evaluation criteria; and
aggregating the results in the execution reports and the evaluation reports to determine whether a candidate query passes the dual validation, wherein the performance reports comprise the execution reports and the evaluation reports.

20. The one or more non-transitory computer-readable media of claim 15 further comprising training a generative model using the multi-turn natural language to query training data.
